(19) United States
(12) Patent Application Publication
(10) Pub. No.: US 2010/0302962 A1
(43) Pub. Date: Dec. 2, 2010

(54) Wireless Terminal, Wireless Base Station, Wireless Communication Method, And Wireless Communication System

(75) Inventor: Yoshiyuki OOTA, Kawasaki (JP)

Correspondence Address: HANIFY & KING PROFESSIONAL CORPORATION, 1055 Thomas Jefferson Street, NW, Suite 400, WASHINGTON, DC, 20007, US

(73) Assignee: FUJITSU LIMITED, Kawasaki-shi (JP)

(21) Appl. No.: 12/768,906

(22) Filed: Apr. 28, 2010

(30) Foreign Application Priority Data
May 29, 2009 (JP) 2009-131545

(51) Int. Cl. H04W 72/04; H04W 24/00

(52) U.S. Cl. 370/252; 370/336

(57) ABSTRACT

A wireless communication method for performing wireless communications between a wireless terminal and a wireless base station during a first time period or a second time period includes determining whether the first time period or the second time period is assigned to the wireless terminal, measuring a quality of a signal to be transmitted during the determined first or second time period, selecting either the first time period or the second time period according to the measured quality of the signal, and reporting selection data indicating the selected first or second time period or reporting measurement data indicating the measured quality of the signal to the wireless base station.

### CROSS-REFERENCE TO RELATED APPLICATIONS

This application is based upon and claims the benefit of priority of Japanese Patent Application No. 2009-131545 filed on May 29, 2009, the entire contents of which are incorporated herein by reference.

### FIELD

The embodiments discussed herein are related to a wireless terminal, a wireless base station, and a wireless communication method, such as, a wireless terminal, a wireless base station, and a wireless communication method applicable for OFDMA (Orthogonal Frequency Division Multiple Access).

### BACKGROUND

In these years, OFDMA (Orthogonal Frequency Division Multiple Access), for example, is used as a wireless communication method by many wireless communication systems (e.g., IEEE 802.16 standard, LTE (Long Term Evolution)).

In some cases with the OFDMA, FFR (Fractional Frequency Reuse) is used for efficient utilization of wireless resources.

In a case of using the FFR, wireless terminals and wireless base stations perform communications using a frequency bandwidth shared with another neighboring wireless base station at one time period. Further, the wireless terminals and the wireless base stations may perform communications using a frequency bandwidth different from that used by the other neighboring wireless base station at another time period or perform communications based on time division.

FIG. 1 is a schematic diagram illustrating a spatial arrangement of frequency bandwidths in a case where FFR is used. FIG. 2 is a schematic diagram illustrating a relationship between the frequency bandwidths of FIG. 1.

In FIG. 1, wireless base stations (BS) 1-3 are allocated. Three cells 11-13 are formed in which corresponding wireless base stations 1-3 are provided at the centers of cells 11-13. The frequency bandwidths used by the cells 11-13 are different between those used at a center part of a cell and those used at a peripheral part of a cell. As illustrated in the lower part of FIG. 2, communications with a wireless terminal are performed by using a shared frequency bandwidth A at the center part of each cell BS1-BS3 (Reuse 1). As illustrated in the upper part of FIG. 2, communications with a wireless terminal are performed by using different frequencies B, C and D formed by dividing the shared frequency bandwidth A into three parts (Reuse 3). For example, BS1 communicates with a wireless terminal by using the shared frequency A at the center part of the cell 11 and communicates with a wireless terminal by using the frequency bandwidth B at the peripheral part of the cell 11.

By arranging the frequencies in this manner, the frequency arrangement of Reuse 1, which has high frequency usage efficiency, and the frequency arrangement of Reuse 3, which improves throughput by reducing the interference with other neighboring cells can be used in combination.

In other words, because the center part of each cell is far from the center part of other surrounding cells, interference at the center part of the cells is little and the same frequency can be arranged at the center parts of the cells. Therefore, frequency is arranged by Reuse 1. On the other hand, interference from neighboring cells will be large and throughput will decrease in a case where Reuse 1 is applied to the peripheral part of the each cell. Therefore, Reuse 3, which uses a different frequency than that of a neighboring cell, is used to arrange frequency. Thereby, the efficiency of frequency usage can be increased at the center part of the cell and interference can be reduced at the peripheral parts of the cell. Thus, the throughput of the entire system can be improved.

FIG. 3 is a schematic diagram illustrating an exemplary configuration of a frame in a case where FFR is applied to OFDMA. The frame illustrated in FIG. 3 is a frame of, for example, BS1 and includes a downlink (DL) sub-frame and an uplink (UL) sub-frame. The DL sub-frame includes a Reuse 1 Zone corresponding to frequency bandwidth A (period when frequency bandwidth A is used) and a Reuse 3 Zone corresponding to bandwidth B (period when frequency bandwidth B is used).

That is, a wireless base station (e.g., BS 1) performs wireless communications with a wireless terminal using a frequency bandwidth shared with other neighboring wireless base stations (e.g., BS 2 and 3 illustrated in FIG. 1) at a predetermined time period (Reuse 1 Zone illustrated in FIG. 3). Further, a wireless base station performs wireless communications with a wireless terminal using another frequency bandwidth (frequency bandwidth B of FIG. 2) which is different from that used by other neighboring wireless base stations at another time period (Reuse 3 Zone illustrated in FIG. 3).

Further, a wireless base station (e.g., BS 1) may divide the other time period and perform wireless communications during the other time period (Reuse 3 Zone illustrated in FIG. 3).

Accordingly, in a case where FFR is applied to OFDMA, it is determined whether to use Reuse 1 Zone or Reuse 3 Zone for performing wireless communications inside a cell.

FIG. 4 is a schematic diagram for describing a method for determining the reuse zone to be used according to a related art example. With this method of the related art example, a wireless terminal (MS) measures the reception quality of a signal 42 of a Reuse 1 Zone included in the DL signals (DL sub-frame) received from a wireless base station (BS).

In a case where the reception quality (measurement value) of the measured by the wireless terminal MS is equal to or greater than a predetermined threshold, the wireless base station BS assigns the wireless terminal MS to an uplink (UL) Reuse 1 Zone when transmitting an uplink signal. That is, the wireless terminal MS transmits an UL signal 46 at a Reuse 1 Zone of an UL sub-frame 45.

On the other hand, in a case where the reception quality (measurement value) of the measured by the wireless terminal MS is less than a predetermined threshold, the wireless base station BS assigns the wireless terminal MS to an uplink (UL) Reuse 3 Zone when transmitting an uplink signal. That is, the wireless terminal MS transmits an UL signal 47 at a Reuse 3 Zone of an UL sub-frame 45. The signal, which is to have reception quality measured (target measurement signal), remains to the signal 42 transmitted at the Reuse 1 Zone regardless of whether the Reuse 1 Zone 1 or the Reuse 3 Zone is assigned to the wireless terminal MS.

FIG. 5 is a schematic diagram for describing another method for determining the reuse zone to be used according to a related art example. With this other method of the related art example, a signal 52, which is to have reception quality measured (target measurement signal), is transmitted from a wireless terminal (Mobile Station, MS) by using a Reuse 1 Zone of an uplink (UL) signal (UL sub-frame) 51. A wireless base station (BS) measures the reception quality of the signal 52 of the UL signal 51 and reports an assignment result of FFR of an uplink.

That is, in a case where the reception quality measured by the wireless base station BS is equal to or greater than a threshold, the wireless base station BS assigns a Reuse 1 Zone to the wireless terminal MS. In other words, the wireless terminal transmits a UL signal 56 by using the Reuse 1 Zone of a UL sub-frame 55.

On the other hand, in a case where the reception quality measured by the wireless base station BS is less than the threshold, the wireless base station BS assigns a Reuse 3 Zone to the wireless terminal MS. In other words, the wireless terminal transmits a UL signal 57 by using the Reuse 3 Zone of the UL sub-frame 55.

In FIG. 5, the target measurement signal is transmitted using all sub-channels at a predetermined time of the Reuse 1 Zone.

However, the transmission conditions of the Reuse 1 Zone and the transmission conditions of the Reuse 3 Zone are different.

With the method described with FIG. 4, the reuse zone cannot be accurately determined because the communication quality using the Reuse 3 Zone is unknown. This results in degradation of throughput.

With the method described with FIG. 5, wireless resources, which are to be used for assigning uplink data, are reduced due to the signals 52 transmitted for measurement in the UL sub-frame 51. This also results in degradation of throughput.

### SUMMARY

According to an aspect of the invention, there is provided a wireless communication method for performing wireless communications between a wireless terminal and a wireless base station during a first time period or a second time period, the wireless communication method including: determining whether the first time period or the second time period is assigned to the wireless terminal; measuring a quality of a signal to be transmitted during the determined first or second time period; selecting either the first time period or the second time period according to the measured quality of the signal; and reporting selection data indicating the selected first or second time period or reporting measurement data indicating the measured quality of the signal to the wireless base station.

The object and advantages of the invention will be realized and attained by means of the elements and combinations particularly pointed out in the claims.

It is to be understood that both the foregoing generation description and the followed detailed description are exemplary and explanatory and are not restrictive of the invention, as claimed.

### BRIEF DESCRIPTION OF DRAWINGS

FIG. 1 is a schematic diagram illustrating a spatial arrangement of frequency bandwidths in a case where FFR is used;

FIG. 2 is a schematic diagram illustrating a relationship between the frequency bandwidths of FIG. 1;

FIG. 3 is a schematic diagram illustrating an exemplary configuration of a frame in a case where FFR is applied to OFDMA;

FIG. 4 is a schematic diagram for describing a method for determining a reuse zone to be used according to a related art example;

FIG. 5 is a schematic diagram for describing another method for determining a reuse zone to be used according to a related art example;

FIG. 6 is a schematic diagram for describing a reference example of a wireless communication method;

FIG. 7 is a flowchart illustrating a wireless communication method according to a first embodiment of the present invention;

FIG. 8 is a block diagram illustrating an exemplary configuration of a wireless terminal according to the first embodiment of the present invention;

FIG. 9 is a block diagram illustrating an exemplary configuration of a base station according to the first embodiment of the present invention;

FIGS. 10A-10C are flowcharts illustrating an operation of the communication method according to a second embodiment of the present invention;

FIGS. 11A-11C are flowcharts illustrating an operation of the communication method according to a third embodiment of the present invention;

FIG. 12 illustrates an exemplary configuration of frames used in the second and third embodiments of the present invention;

FIG. 13 is a block diagram illustrating an exemplary configuration of a wireless terminal according to the second and third embodiments of the present invention;

FIG. 14 is a block diagram illustrating an exemplary configuration of a wireless base station according to the second and third embodiments of the present invention;

FIG. 15 is a schematic diagram illustrating an example of an MCS table;

FIG. 16 illustrates allocation of wireless terminals in an exemplary wireless communication system;

FIG. 17 illustrates the results of calculating the number of transmission bits in a case where a related art example is applied to the wireless communication system of FIG. 16 and a case where an embodiment of the present invention is applied to the wireless communication system of FIG. 16;

FIGS. 18A through 18C illustrate examples where one wireless base station performs wireless communications by using a frequency bandwidth different from that of an adjacent wireless base station in a Reuse 3 Zone;

FIGS. 19A through 19C illustrate examples where one wireless base station performs wireless communications with an adjacent wireless base station by time division;

FIG. 20 is a schematic diagram illustrating a part of a multi-hop relay network applying a fourth embodiment of the present invention;

FIG. 21 illustrates an exemplary configuration of frames used in the fourth embodiment of the present invention;

FIG. 22 is a block diagram illustrating an exemplary configuration of a wireless terminal according to the fourth embodiment of the present invention; and

FIG. 23 is a block diagram illustrating an exemplary configuration of a wireless base station according to the fourth embodiment of the present invention.

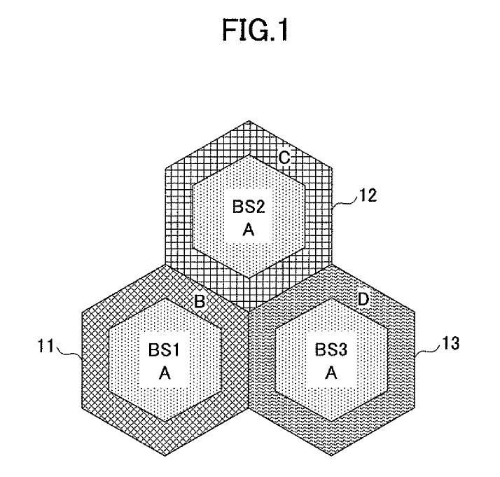

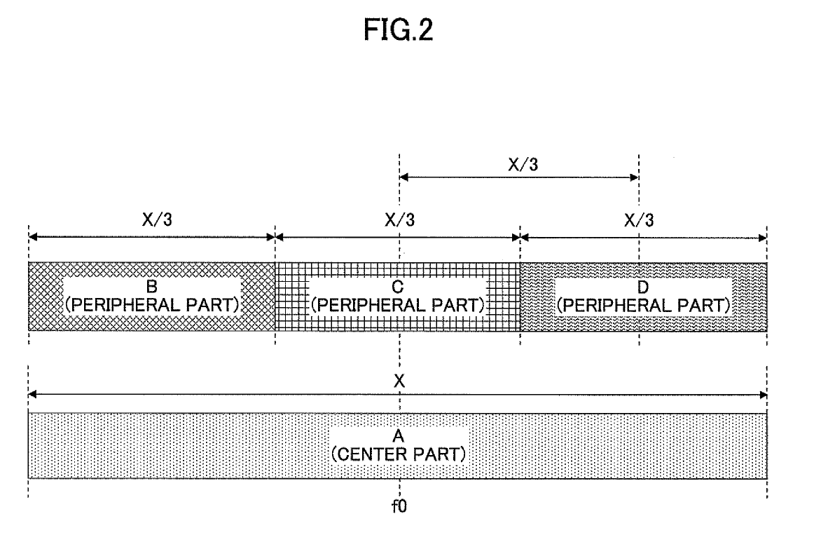

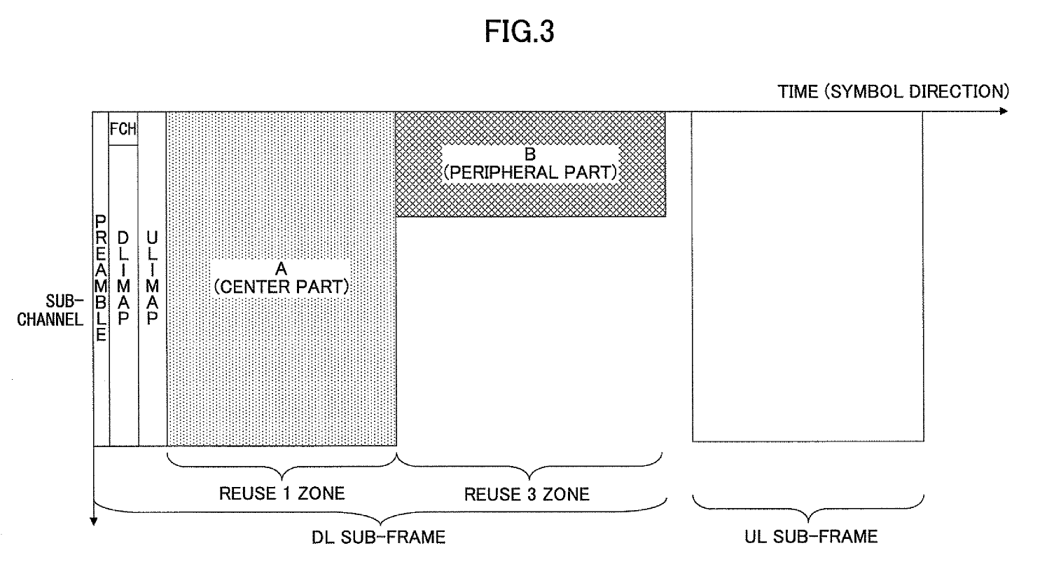

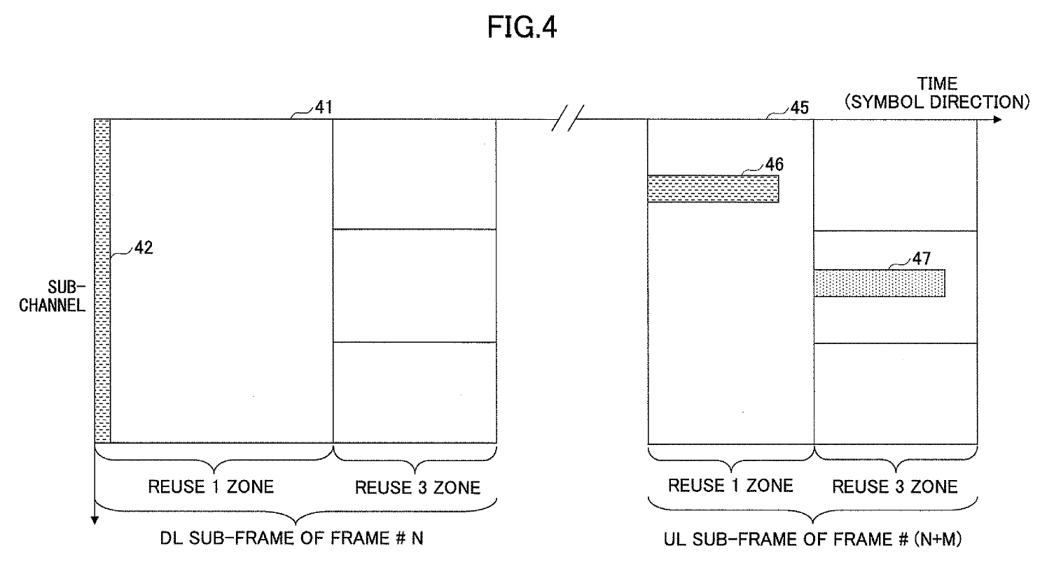

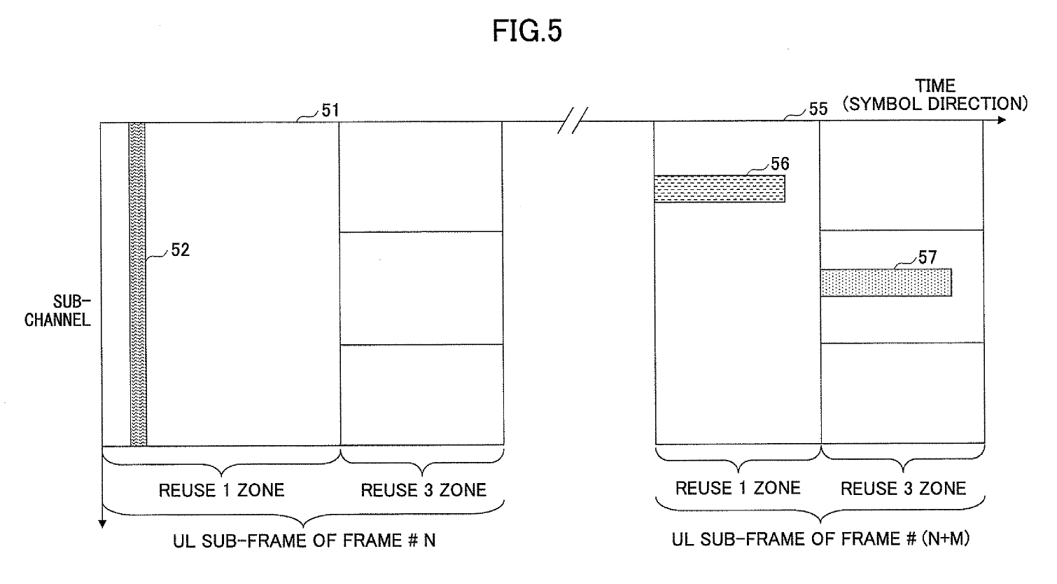

### DESCRIPTION OF EMBODIMENTS

In the following, embodiments of the present invention are described with reference to the accompanying drawings. Although the following description and the accompanying drawings illustrate each cell having a Reuse 1 Zone and a Reuse 3 Zone, each cell may have 3 or more reuse zones. Further, the frequency reuse coefficient may be 4 or more. Alternatively, the frequency reuse coefficient may be less than 3.

In order to determine the reuse zone to be used for uplink (or downlink) with greater accuracy, there is a method of measuring the signal qualities of the Reuse 1 Zone and the Reuse 3 Zone.

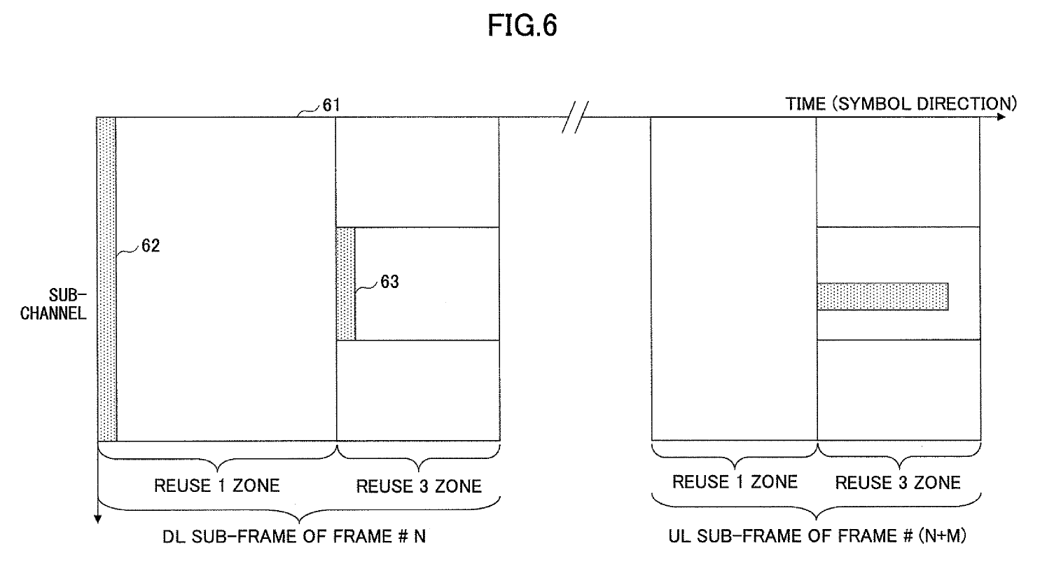

For example, as illustrated in FIG. 6, a wireless terminal MS measures the signal quality of the Reuse 1 Zone of a DL (Downlink) signal (DL sub-frame) 62 and the signal quality of the Reuse 3 Zone of a DL signal (DL subframe) 63. Based on the results of the measurement, the reuse zone to be used in the uplink (or downlink) can be decided. For example, the wireless terminal MS can feedback the results of measuring the signal qualities of both the Reuse 1 zone and the Reuse 3 Zone, so that the base station BS can decide which reuse zone to use based on the measurement results.

However, with the above-described method, a large proportion of communication capacity is consumed due to the large amount of data fed back from the wireless terminal MS to the base station BS. Further, the workload of the wireless terminal MS is increased by the measuring of the signal qualities of reception signals for selecting the Reuse 1 Zone and the Reuse 3 Zone.

Therefore, according to an embodiment of the present invention, the wireless terminal MS measures the signal quality of either the Reuse 1 Zone or the Reuse 3 Zone, selects a reuse zone based on the result of the measurement, and feeds the result of the selection or the result of the measurement to the base station BS. Thus, neither the signal qualities of both the Reuse 1 Zone and the Reuse 3 Zone need to be measured nor the results of measurement need to be transmitted to the base station BS. For example, a wireless terminal MS, which is assigned with the Reuse 3 Zone, measures the reception quality of signals transmitted by using the Reuse 3 Zone (e.g., individual pilot signals). In a case where the measured reception quality is lower than a predetermined threshold, the mobile station MS continues to use the Reuse 3 Zone. On the other hand, in a case where the measured reception quality is higher than a predetermined threshold, the wireless terminal MS changes from communications using the Reuse 3 Zone to communications using the Reuse 1 Zone.

In a case where reception quality is less than a predetermined threshold for both the Reuse 1 Zone and the Reuse 3 Zone, the assigning of wireless resources may be interrupted until transmission conditions recover and the reception quality becomes greater than the predetermined threshold.

Accordingly, a suitable reuse zone can be decided in correspondence with the transmission conditions of each of the reuse zones. Thereby, throughput can be improved.

Further, in an uplink, only the quality measurement result of either the Reuse 1 Zone or the Reuse 3 Zone needs to be transmitted. Alternatively, in an uplink, only the zone selection result and the MCS (Modulation and Coding Scheme) selection result need to be transmitted.

Further, throughput is also increased because transmission of signals for measuring uplink quality is unnecessary for selecting a reuse zone.

Next, embodiments of the present invention are described in further detail with reference to the accompanying drawings.

### First Embodiment

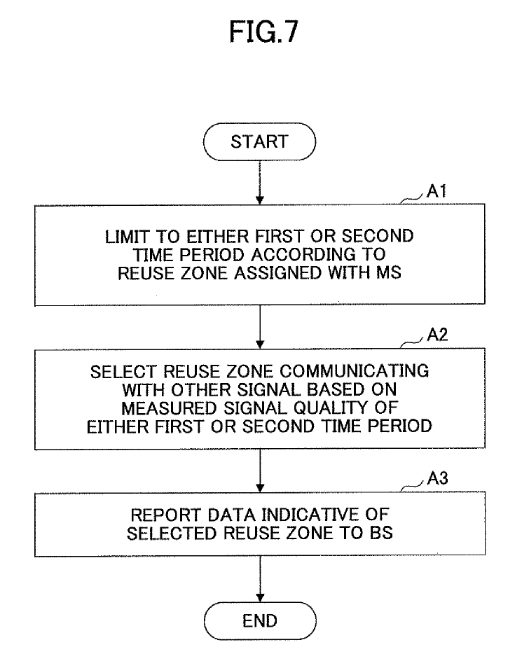

A wireless communication method according to the first embodiment of the present invention is described with reference to FIG. 7.

In Step A1 (measuring step), either a first time period or a second time period, which correspond to a reuse zone assigned with a wireless terminal, is designated, and the signal quality of the designated time period is measured.

In the first time period (e.g., Reuse 1 Zone), wireless communications are performed with a wireless terminal MS located at a center part of a wireless area of a base station B. In the second time period (e.g., Reuse 3 Zone), wireless communications are performed with a wireless station MS located at an area separated from the center of the wireless area of the base station B.

The signal measured by the wireless terminal MS is, for example, an individual pilot signal included in an OFDMA sub-frame. The reception quality of the signal measured by the wireless terminal MS is, for example, CINR (Carrier to Interference plus Noise Ratio).

In Step A2 (selecting step), a reuse zone communicating with another signal is selected based on the signal quality of the first or second time period measured in Step A1 (selecting step).

Although the selection of the reuse zone is performed by comparing the measured signal quality with a predetermined threshold, the selection of the reuse zone may also be performed by using a suitable algorithm. For example, in the selection of the reuse zone, identification data of the reuse zone to be selected may be selected together with selecting a changed modulation and coding scheme (MCS). The other signal may be, for example, an uplink signal (transmission data).

In Step A3 (reporting step), data indicating the reuse zone selected in Step A2 is reported to the base station BS.

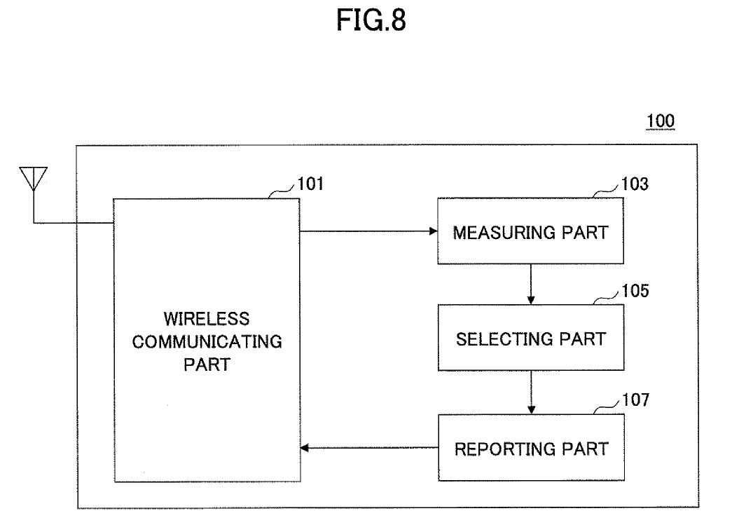

Next, a wireless terminal (MS) 100 according to the first embodiment of the present invention is described with reference to FIG. 8.

The wireless terminal 100 includes a wireless communicating part 101, a measuring part 103, a selecting part 105, and a reporting part 107. The wireless communicating part 101 performs wireless communications with a wireless base station. The wireless communicating part 101 is connected to the measuring part 103. The wireless communicating part 101 receives a signal, modulates the received signal, and transmits the modulated signal to the measuring part 103.

The measuring part 103 measures the quality of the signal of the first time period or the second time period according to the reuse zone (Reuse 1 Zone or Reuse 3 Zone) assigned to the wireless terminal 100. That is, the measuring part 103 measures the quality of the signal of the first time period in a case where the Reuse 1 Zone is assigned to the wireless terminal 100 and measures the quality of the signal of the second time period in a case where the Reuse 3 Zone is assigned to the wireless terminal 100. The measured signal is, for example, an individual pilot signal. The reception quality of the measured signal is, for example, CINR (Carrier to Interference plus Noise Ratio). The measuring part 103, which is connected to the selecting part 105, sends the quality of the measured signal to the selecting part 105.

The selecting part 105 selects a reuse zone to be used for performing data communications based on the signal quality measured by the measuring part 103. Although the selection of the reuse zone can be performed by comparing the measured signal quality with a predetermined threshold, the selection of the reuse zone may also be performed by using a suitable algorithm. For example, in addition to selecting the reuse zone, a changed modulation and coding scheme (MCS) may be selected. The signal for performing the data communications may be, for example, an uplink signal. The selecting part 105, which is connected to the reporting part 107, outputs identification data of the selected reuse zone to the reporting part 107.

The reporting part 107 reports reuse zone data indicating the reuse zone selected by the selecting part 105. The reuse zone data includes, for example, data identifying the reuse zone to be changed. In a case where a changed MCS is selected by the selecting part 105, the reuse zone can be reported together with data indicating the selected changed MCS. The reporting part 107, which is connected to the wireless communicating part 101, transmits a signal indicating the selected reuse zone to, for example, the below-described wireless base station 200 via the wireless communicating part 101.

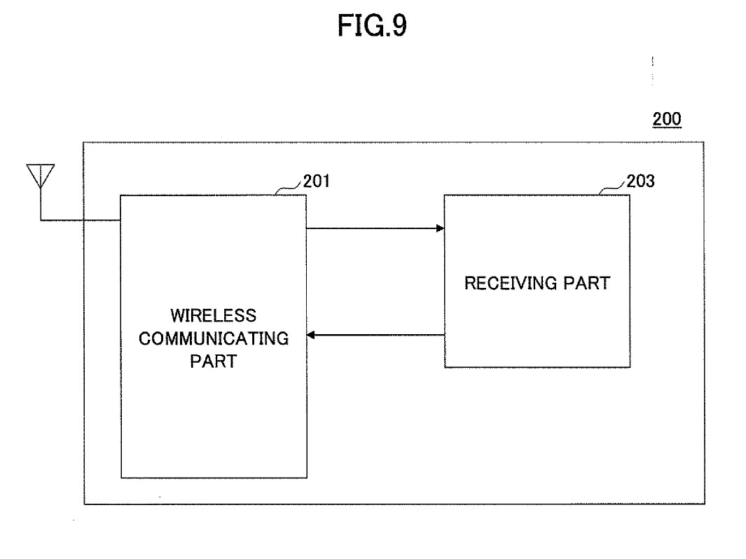

Next, a wireless base station 200 according to the first embodiment of the present invention is described with reference to FIG. 9.

The wireless base station 200 includes a wireless communicating part 201 and a receiving part 203. The wireless communicating part 201 performs wireless communications with, for example, the wireless terminal 100 of FIG. 8. The wireless communicating part 201, which is connected to the receiving part 203, decodes the signal received from the wireless terminal 100 and sends the decoded signal to the receiving part 203. The signal sent to the receiving part 203 includes reuse zone data indicating the reuse zone to be used for performing data communications. The reuse zone indicated in the reuse zone data is selected by the wireless terminal 100 based on the signal quality of the first or second time period according to the reuse zone (Reuse 1 Zone, Reuse 3 Zone) assigned to the wireless terminal 100.

The receiving part 203 receives the signal (report) including the reuse zone data. The receiving part 203 reports the received reuse zone data to the wireless communicating part 201. Further, in a case where MCS data are transmitted together with the reuse zone data, the receiving part 203 also receives the MCS data. The wireless communicating part 201 schedules wireless resources for communicating with the wireless terminal 100 based on the reuse zone data (and the MCS data).

### Second Embodiment

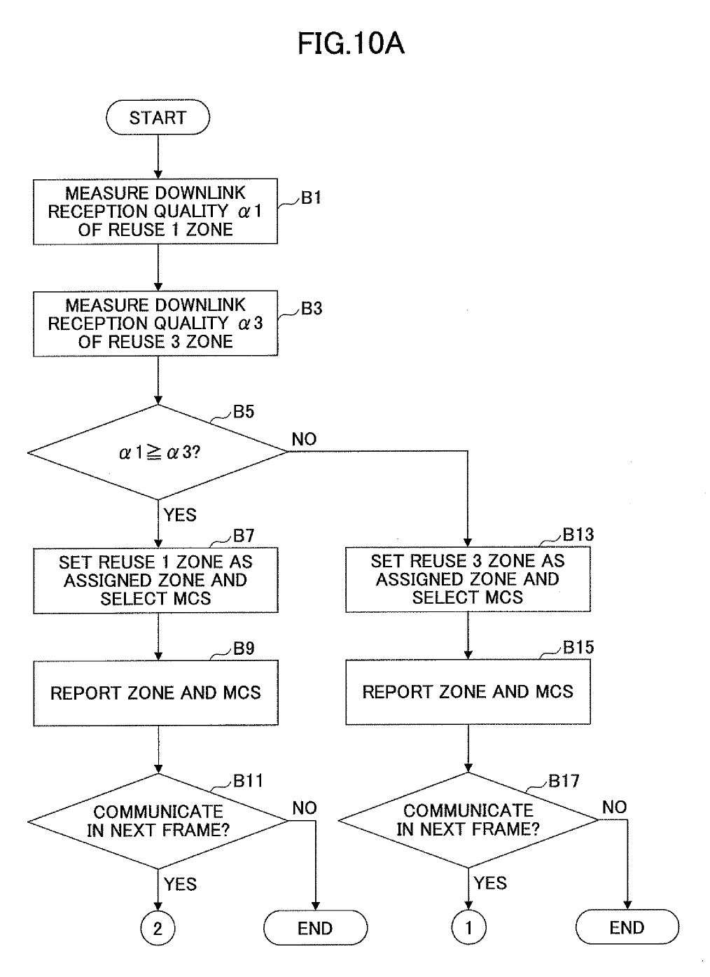

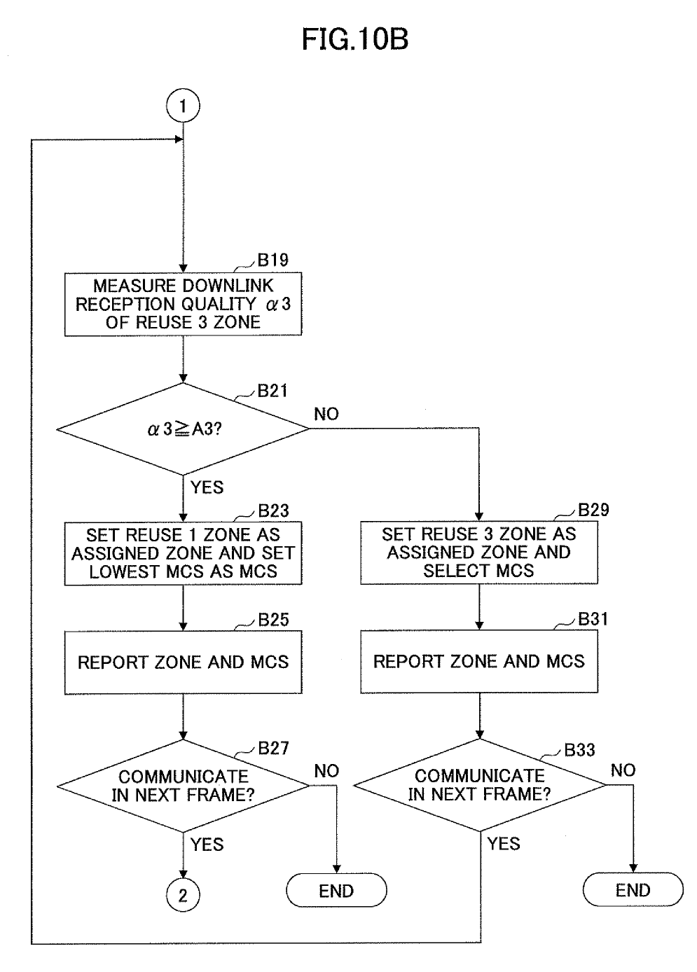

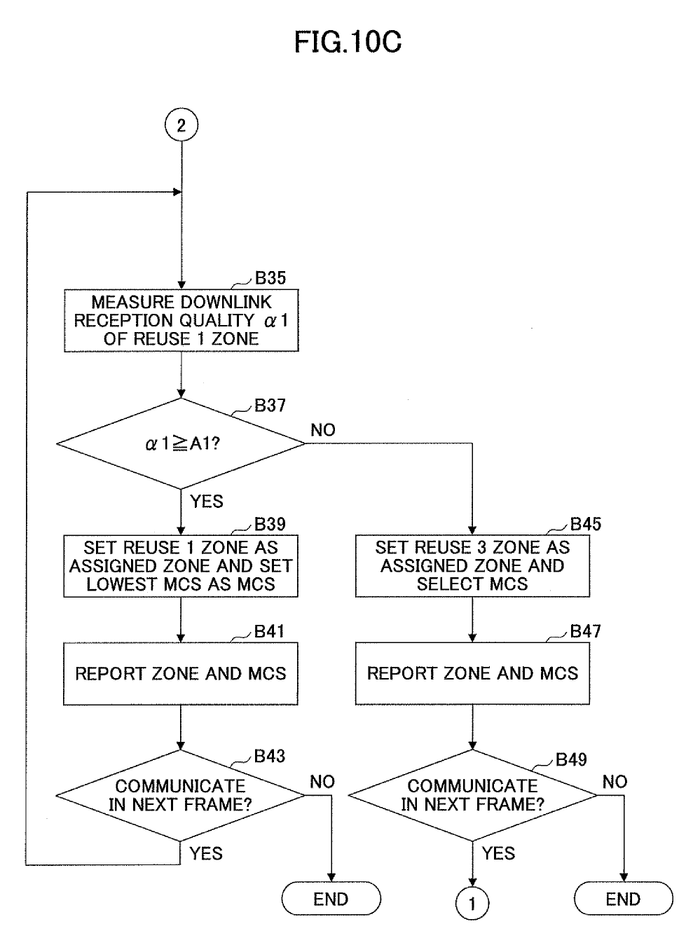

Next, a communication method according to a second embodiment of the present invention is described with reference to FIGS. 10A-10C. FIGS. 10A-10C are flowcharts illustrating an operation of the communication method according to the second embodiment of the present invention.

In the second embodiment, a wireless terminal MS selects a reuse zone and a MCS and reports data of the selected reuse zone and data of the selected MCS to a base station BS. According to another embodiment of the present invention, the wireless terminal MS may measure signal quality, report the measured signal quality to the base station BS, and allow the BS to decide (select) the reuse zone and the MCS.

The communication method according to the second embodiment of the present invention starts in a state where a reuse zone is not yet assigned.

In Step B1, the wireless terminal MS measures a reception quality α1 of a downlink signal in the Reuse 1 Zone. The signal in which reception quality is measured is, for example, an individual pilot signal.

Then, in Step B3, the wireless terminal MS measures a reception quality α3 of a downlink signal in the Reuse 3 Zone.

Then, in Step B5, the wireless terminal MS compares the reception quality α1 with the reception quality α3. In a case where the reception quality α1 is equal to or greater than the reception quality α3 (Yes in Step B5), the operation of the communication method of the second embodiment proceeds to Step B7.

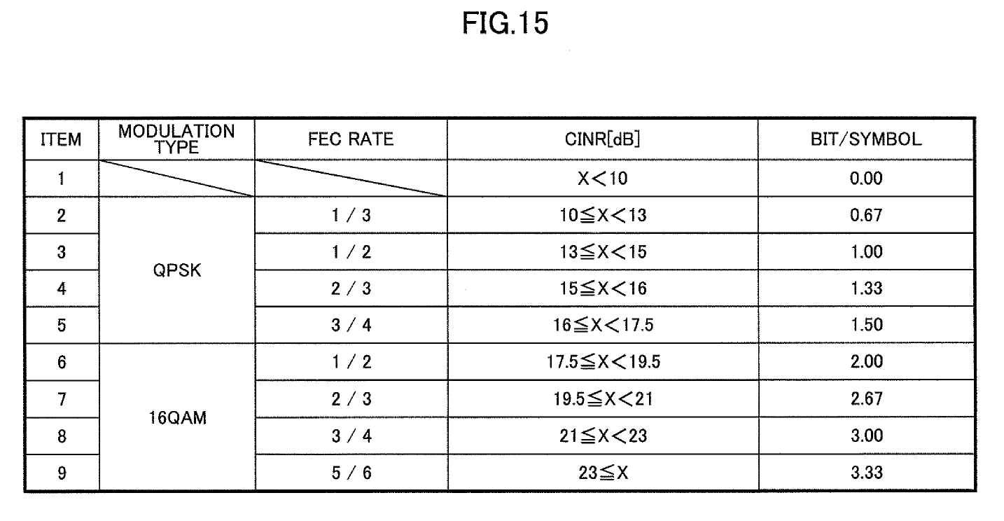

In Step B7, the wireless terminal MS sets the Reuse 1 Zone as the reuse zone assigned to the wireless terminal MS itself and selects a MCS based on a MCS table. An example of the MCS table is illustrated in detail in FIG. 15.

Then, in Step B9, the wireless terminal MS reports zone data and a MCS result to the base station BS.

Then, in Step B11, the wireless terminal MS determines whether to perform communications in a next frame. In a case where communications are to be performed in a next frame (Yes in Step B11), the operation proceeds to Step B35 (see FIG. 100). The steps illustrated in FIG. 100 are described in detail below.

In a case where communications are not to be performed in a next frame (No in Step B11), the operation of the communication method of the second embodiment is completed.

In a case where the reception quality α1 is less than the reception quality α3 (No in Step B5), the operation of the communication method of the second embodiment proceeds to Step B13.

In Step B13, the wireless terminal MS sets the Reuse 3 Zone as the reuse zone assigned to the wireless terminal MS itself and selects a MCS based on the MCS table.

Then, in Step B15, the wireless terminal MS reports zone data and a MCS result to the base station BS.

Then, in Step B17, the wireless terminal MS determines whether to perform communications in a next frame. In a case where communications are to be performed in a next frame (Yes in Step B17), the operation proceeds to Step B19 (see FIG. 10B). The steps illustrated in FIG. 10B are described in detail below.

In a case where communications are not to be performed in a next frame (No in Step B17), the operation of the communication method of the second embodiment is completed.

In Step B19, the wireless terminal MS measures the reception quality α3 of the downlink signal in the Reuse 3 Zone.

Then, in Step B21, the wireless terminal MS compares the reception quality α3 to a threshold A3. The threshold A3 is a value defining the boundary between the Reuse 1 Zone and the Reuse 3 Zone for the Reuse 3 Zone. In a case where the reception quality α3 is equal to or greater than the threshold A3 (Yes in Step B21), the operation of the communication method of the second embodiment proceeds to Step B23.

In Step B23, the wireless terminal MS sets the Reuse 1 Zone as the reuse zone assigned to the wireless terminal MS itself and selects a MCS which is applied when transmission conditions are the worst (e.g., QPSK in which the FEC rate is ½).

Then, in Step B25, the wireless terminal MS reports zone data and a MCS result to the base station BS.

Then, in Step B27, the wireless terminal MS determines whether to perform communications in a next frame. In a case where communications are to be performed in a next frame (Yes in Step B27), the operation proceeds to Step B35 (see FIG. 10C). The steps illustrated in FIG. 10C are described in detail below.

In a case where communications are not to be performed in a next frame (No in Step B27), the operation of the communication method of the second embodiment is completed.

In a case where the reception quality α3 is lower than the threshold A3 (No in Step B21), the operation proceeds to Step B29.

In Step B29, the wireless terminal MS sets the Reuse 3 Zone as the reuse zone assigned to the wireless terminal MS itself and selects a MCS based on the MCS table.

Then, in Step B31, the wireless terminal MS reports zone data and a MCS result to the base station BS.

Then, in Step B33, the wireless terminal MS determines whether to perform communications in a next frame. In a case where communications are to be performed in a next frame (Yes in Step B33), the operation returns to Step B19 and the operation is repeated.

In a case where communications are not to be performed in a next frame (No in Step B33), the operation of the communication method of the second embodiment is completed.

Next, FIG. 100 is described in detail.

In Step B35, the wireless terminal MS measures the reception quality α1 of the downlink signal in the Reuse 1 Zone.

Then, in Step B37, the wireless terminal MS compares the reception signal α1 to a threshold A1. The threshold A1 is a value defining the boundary between the Reuse 1 Zone and the Reuse 3 Zone for the Reuse 1 Zone. In a case where the reception signal α1 is equal to or greater than the threshold A1, the operation proceeds to Step B39.

In Step B39, the wireless station MS sets the Reuse 1 Zone as the reuse zone assigned to the wireless terminal MS itself and selects a MCS which is applied when transmission conditions are the worst (e.g., QPSK in which the FEC rate is ½).

Then, in Step B41, the wireless terminal MS reports zone data and a MCS result to the base station BS.

Then, in Step B43, the wireless terminal MS determines whether to perform communications in a next frame. In a case where communications are to be performed in a next frame (Yes in Step B43), the operation returns to Step B35.

In a case where communications are not to be performed in a next frame (No in Step B43), the operation of the communication method of the second embodiment is completed.

In a case where the reception quality α1 is less than the threshold A1, the operation proceeds to Step B45.

In Step B45, the wireless terminal MS sets the Reuse 3 Zone as the reuse zone assigned to the wireless terminal MS itself and selects a MCS based on the MCS table.

Then, in Step B47, the wireless terminal MS reports zone data and a MCS result to the base station BS.

Then, in Step B49, the wireless terminal MS determines whether to perform communications in a next frame. In a case where communications are to be performed in a next frame (Yes in Step B49), the operation returns to Step B19 (see FIG. 10B) and the operation is repeated.

In a case where communications are not to be performed in a next frame (No in Step B49), the operation of the communication method of the second embodiment is completed.

### Third Embodiment

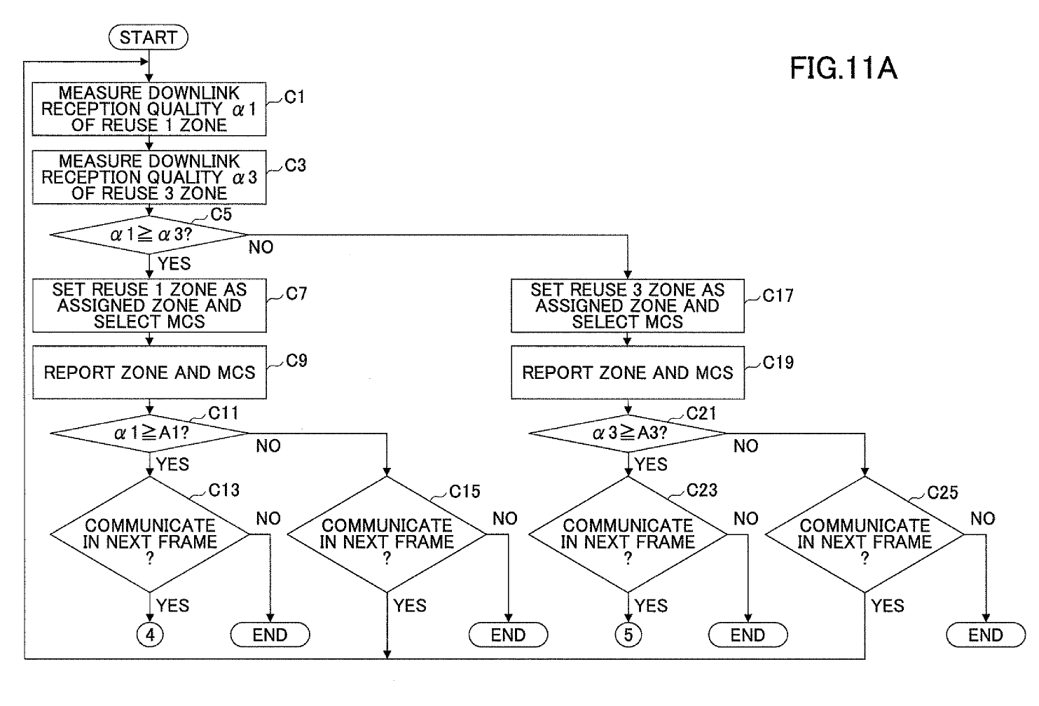

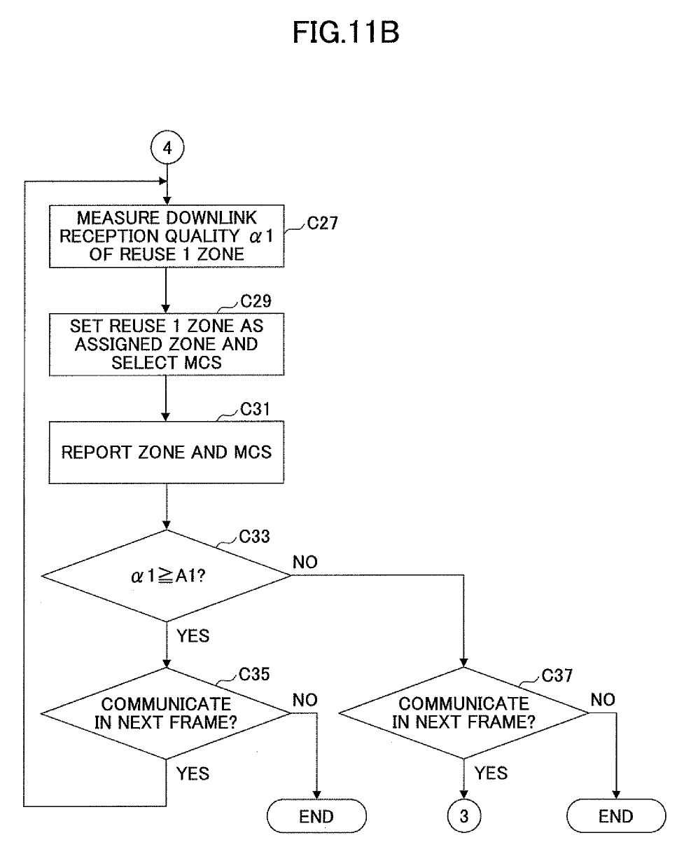

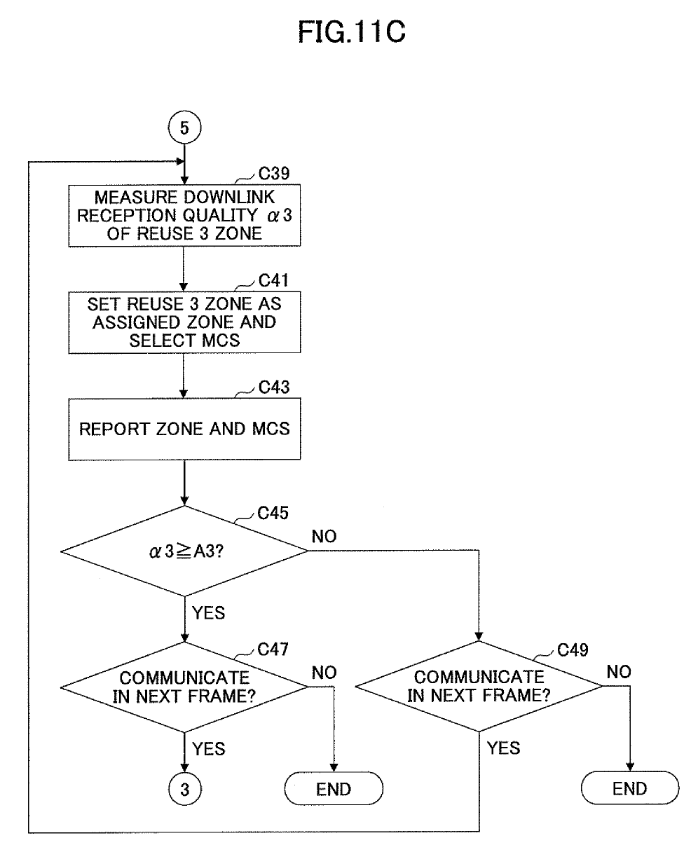

Next, a communication method according to a third embodiment of the present invention is described with reference to FIGS. 11A-11C. FIGS. 11A-11C are flowcharts illustrating an operation of the communication method according to the third embodiment of the present invention.

In the communication method according to the third embodiment of the present invention, a cell is divided into first to fourth areas. The first area is an area in the Reuse 1 Zone that is located near the base station BS. The second area is an area in the Reuse 1 Zone that is located far from the base station BS (i.e. an area in the Reuse 1 Zone that is located near the Reuse 3 Zone). The third area is an area in the Reuse 3 Zone that is located near the base station BS (i.e. an area in the Reuse 3 Zone that is located near the Reuse 1 Zone). The fourth area is an area in the Reuse 3 Zone that is located far from the base station BS (i.e. an area near the cell edge).

In the first area, only the reception quality of the Reuse 1 Zone is measured. In the second area, the reception qualities of both the Reuse 1 Zone and the Reuse 3 Zone are measured. In the third area, the reception qualities of both the Reuse 1 Zone and the Reuse 3 Zone are measured. In the fourth area, only the reception quality of the Reuse 3 Zone is measured.

Thereby, the workload of measuring reception quality can be reduced for the wireless terminal MS.

In the third embodiment, the wireless terminal MS selects a reuse zone and a MCS and reports data of the selected reuse zone and data of the selected MCS to the base station BS. According to another embodiment of the present invention, the wireless terminal MS may measure signal quality, report the measured signal quality to the base station BS, and allow the BS to decide (select) the reuse zone and the MCS.

The communication method according to the third embodiment of the present invention starts in a state where a reuse zone is not yet assigned.

In Step C1, the wireless terminal MS measures a reception quality α1 of a downlink signal in the Reuse 1 Zone. The signal in which reception quality is measured is, for example, an individual pilot signal.

Then, in Step C3, the wireless terminal MS measures a reception quality α3 of a downlink signal in the Reuse 3 Zone. The signal in which reception quality is measured is, for example, an individual pilot signal.

Then, in Step C5, the wireless terminal MS compares the reception quality α1 with the reception quality α3. In a case where the reception quality α1 is equal to or greater than the reception quality α3 (Yes in Step C5), the operation of the communication embodiment of the third embodiment proceeds to Step C7.

In Step C7, the wireless terminal MS sets the Reuse 1 Zone as the reuse zone assigned to the wireless terminal MS itself and selects a MCS based on a MCS table.

Then, in Step C9, the wireless terminal MS reports zone data and a MCS result to the base station BS.

Then, in Step C11, the wireless terminal MS compares the reception quality α1 with a predetermined threshold A′1 for determining whether the wireless terminal MS is near or far from the base station BS in the Reuse 1 Zone. Then, in a case where the reception quality α1 is equal to or greater than the threshold A′1 (Yes in Step C11), the operation of the communication method of the third embodiment proceeds to Step C13. In a case where the reception quality α1 is less than the threshold A′1 (No in Step C11), the operation of the communication method of the third embodiment proceeds to Step C15.

In Step C13, the wireless terminal MS determines whether to perform communications in a next frame. In a case where communications are to be performed in a next frame (Yes in Step C13), the operation proceeds to Step C27 (see FIG. 11B). In a case where communications are not to be performed in a next frame (No in Step C13), the operation of the communication method of the third embodiment is completed.

In Step C15, the wireless terminal MS determines whether to perform communications in a next frame. In a case where communications are to be performed in a next frame (Yes in Step C15), the operation returns to Step C1 and the operation is repeated. In a case where communications are not to be performed in a next frame (No in Step C15), the operation of the communication method of the third embodiment is completed.

On the other hand, in a case where the reception quality α1 is less than the reception quality α3 (No in Step C5), the operation of the communication method of the third embodiment proceeds to Step C17.

In Step C17, the wireless terminal MS sets the Reuse 3 Zone as the reuse zone assigned to the wireless terminal MS itself and selects a MCS based on the MCS table.

Then, in Step C19, the wireless terminal MS reports zone data and a MCS result to the base station BS.

Then, in Step C21, the wireless terminal MS compares the reception quality α3 with a predetermined threshold A′3 for determining whether the wireless terminal MS is near or far from the base station BS in the Reuse 3 Zone. Then, in a case where the reception quality α3 is equal to or greater than the threshold A′3 (Yes in Step C21), the operation of the communication method of the third embodiment proceeds to Step C23. In a case where the reception quality α3 is less than the threshold A′3 (No in Step C21), the operation of the communication method of the third embodiment proceeds to Step C25.

In Step C23, the wireless terminal MS determines whether to perform communications in a next frame. In a case where communications are to be performed in a next frame (Yes in Step C23), the operation proceeds to Step C39. In a case where communications are not to be performed in a next frame (No in Step C23), the operation of the communication method of the third embodiment is completed.

In Step C25, the wireless terminal MS determines whether to perform communications in a next frame. In a case where communications are to be performed in a next frame (Yes in Step C25), the operation returns to Step C1 and the operation is repeated. In a case where communications are not to be performed in a next frame (No in Step C25), the operation of the communication method of the third embodiment is completed.

Then, in Step C27 (see FIG. 11B), the wireless terminal MS measures a reception quality a 1 of a downlink signal in the Reuse 1 Zone. The signal in which reception quality is measured is, for example, an individual pilot signal.

In Step C29, the wireless terminal MS sets the Reuse 1 Zone as the reuse zone assigned to the wireless terminal MS itself and selects a MCS based on a MCS table.

Then, in Step C31, the wireless terminal MS reports zone data and a MCS result to the base station BS.

Then, in Step C33, the wireless terminal MS compares the reception quality α1 with a predetermined threshold A′1 for determining whether the wireless terminal MS is near or far from the base station BS in the Reuse 1 Zone. Then, in a case where the reception quality α1 is equal to or greater than the threshold A′1 (Yes in Step C33), the operation of the communication method of the third embodiment proceeds to Step C35. In a case where the reception quality α1 is less than the threshold A′1 (No in Step C33), the operation of the communication method of the third embodiment proceeds to Step C37. Thus, in Step C33, it is determined whether the wireless terminal MS in the Reuse 1 Zone is located near to or far from the Reuse 3 Zone.

In Step C35, the wireless terminal MS determines whether to perform communications in a next frame. In a case where communications are to be performed in a next frame (Yes in Step C35), the operation returns to Step C27 and the operation is repeated. In a case where communications are not to be performed in a next frame (No in Step C35), the operation of the communication method of the third embodiment is completed.

In Step C37, the wireless terminal MS determines whether to perform communications in a next frame. In a case where communications are to be performed in a next frame (Yes in Step C37), the operation returns to Step C1 (see FIG. 11A). In a case where communications are not to be performed in a next frame (No in Step C37), the operation of the communication method of the third embodiment is completed.

On the other hand, in Step C39 (subsequent to Step C23 of FIG. 11A), the wireless terminal MS measures a reception quality α3 of a downlink signal in the Reuse 3 Zone.

In Step C41, the wireless terminal MS sets the Reuse 3 Zone as the reuse zone assigned to the wireless terminal MS itself and selects a MCS based on a MCS table.

Then, in Step C43, the wireless terminal MS reports zone data and a MCS result to the base station BS.

Then, in Step C45, the wireless terminal MS compares the reception quality α3 with a predetermined threshold A′3 for determining whether the wireless terminal MS is near or far from the base station BS in the Reuse 3 Zone. Then, in a case where the reception quality α3 is equal to or greater than the threshold A′3 (Yes in Step C45), the operation of the communication method of the third embodiment proceeds to Step C47. In a case where the reception quality α3 is less than the threshold A′3 (No in Step C45), the operation of the communication method of the third embodiment proceeds to Step C49. Thus, in Step C45, it is determined whether the wireless terminal MS in the Reuse 3 Zone is located near to or far from the Reuse 1 Zone.

In Step C47, the wireless terminal MS determines whether to perform communications in a next frame. In a case where communications are to be performed in a next frame (Yes in Step C47), the operation returns to Step C13 and the operation is repeated. In a case where communications are not to be performed in a next frame (No in Step C47), the operation of the communication method of the third embodiment is completed.

In Step C49, the wireless terminal MS determines whether to perform communications in a next frame. In a case where communications are to be performed in a next frame (Yes in Step C49), the operation returns to Step C1 and the operation is repeated. In a case where communications are not to be performed in a next frame (No in Step C49), the operation of the communication method of the third embodiment is completed.

### [Supplementary Explanation of Second and Third Embodiments]

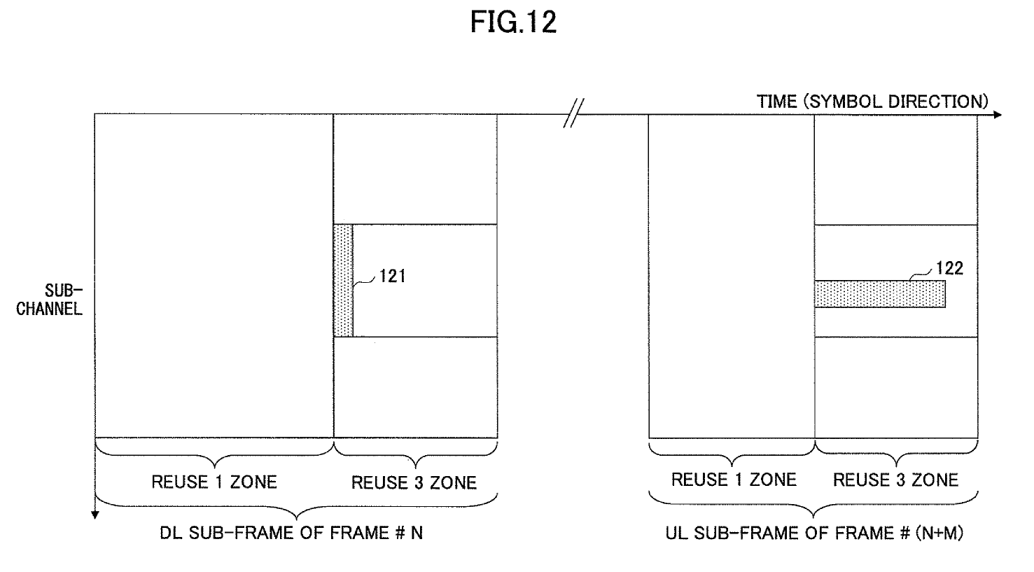

Next, a supplementary explanation of the second and third embodiments of the present invention is given with reference to FIG. 12. FIG. 12 illustrates an exemplary configuration of frames used in the second and third embodiments of the present invention. As described in the second and third embodiments of the present invention, it is supposed that the wireless terminal MS is assigned to the Reuse 3 Zone. The wireless terminal MS measures the reception quality of a signal 121 of a Reuse 3 Zone in a downlink frame. In a case where the measured reception quality is less than a predetermined threshold, the wireless terminal MS determines that the Reuse 3 Zone does not have to be changed to another reuse zone (e.g., Reuse 1 Zone) and that the wireless terminal MS itself can continue using the Reuse 3 Zone. Then, in the Reuse 3 Zone of an uplink frame, the wireless terminal MS performs burst allocation as illustrated with reference numeral 122 in FIG. 12.

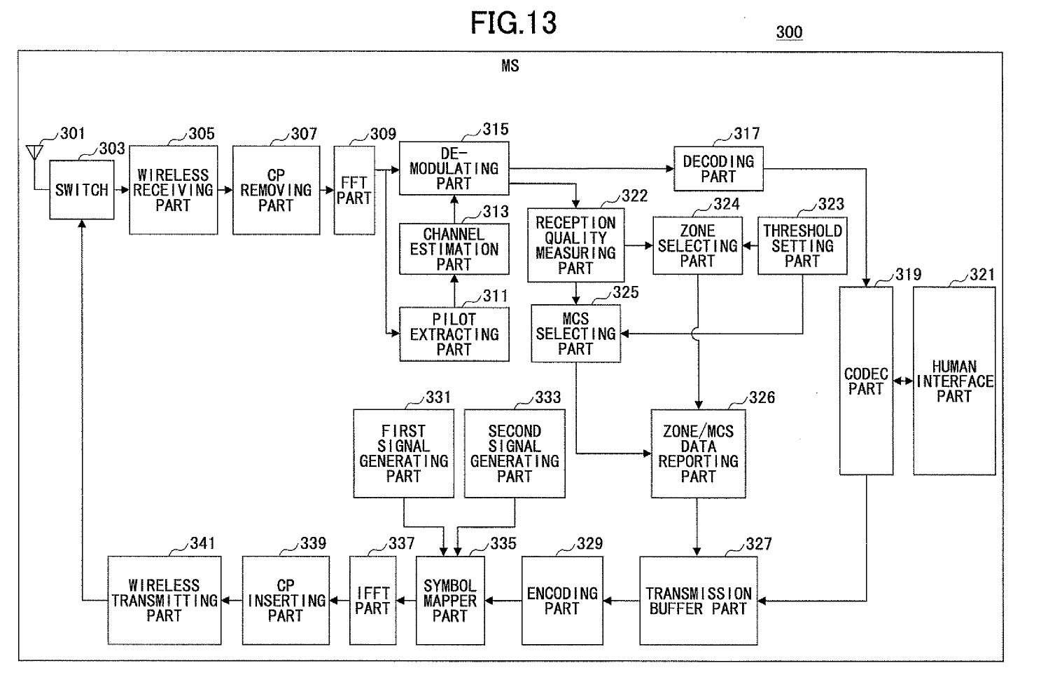

An exemplary configuration of the wireless terminal MS performing the above-described communication method according to the second and third embodiments of the present invention is described with reference to FIG. 13.

FIG. 13 is a block diagram illustrating an exemplary configuration of a wireless terminal (MS) 300 according to the second and third embodiments of the present invention.

Components included in the wireless terminal 300 are described below.

An antenna part 301 communicates with a wireless base station BS (e.g., below-described wireless base station 400) by transmitting and receiving a wireless signal(s) to and from the wireless base station BS. A switch part 303, which is connected to the antenna part 301, switches back and forth between signal transmission and signal reception. A wireless receiving part 305, which is connected to the switch part 303, includes a down-converter that amplifies the wireless signal received by the antenna part 301 and converts the amplified signal into baseband signals.

A CP removing part 307, which is connected to the wireless receiving part 305, removes (extracts) a CP part from the baseband signals. A FFT processing part 309, which is connected to the CP removing part 307, extracts data from the CP part by performing a Fast Fourier Transform (FFT) process on an OFDMA signal. A pilot extracting part 311 extracts a pilot signal from the OFDMA signal subjected to the FFT process.

A channel estimating part 313, which is connected to the pilot extracting part 311 estimates transmission conditions (Channel Estimation) based on the extracted pilot signal. A demodulating part 315 corrects and demodulates the data from the FFT processing part 309 by referring to the transmission conditions estimated by the channel estimating part 313.

A decoding part 317 decodes the data demodulated by the demodulating part 315. A codec (CODEC) part 319 converts the data decoded by the decoding part 317 into, for example, audio signals.

A human interface part 321 provides an interface for enabling signals from, for example, a keyboard, a microphone, or a speaker (not illustrated) to connect with the codec part 319. A reception quality measuring part 322 measures the reception quality of downlink signals from the demodulating part 315. A threshold setting part 323 sets a threshold(s) for selecting a reuse zone and a MCS.

A zone selecting part 324 selects a reuse zone to be assigned to the wireless terminal 300 (i.e. a reuse zone that the wireless terminal 300 belongs) based on data of the reception quality measured by the reception quality measuring part 322 and the threshold (zone setting data) set by the threshold setting part 323 and sends data of the selected reuse zone (assigned zone data) to a zone/MCS data reporting part 326. A MCS selecting part 325 selects a MCS based on data of the reception quality measured by the reception quality measuring part 322 and the threshold (MCS setting data) set by the threshold setting part 323 and sends data of the selected MCS (MCS data) to the zone/MCS data reporting part 326. The zone/MCS data reporting part 326 generates zone/MCS data based on the assigned zone data from the zone selecting part 324 and the MCS data from the MCS selecting part 325.

A transmission buffer part 327 acts as a buffer between an uplink signal from the codec part 319 and zone/MCS data generated by the zone/MCS data reporting part 326. An encoding part 329 encodes signals output from the transmission buffer part 327. A first signal generating part 331 generates an uplink pilot signal.

A second signal generating part 333 generates, for example, a Ranging (Rang) signal, a Bandwidth Request (BWRQ) signal, and a Fast Feedback (FFB) signal. A symbol mapper part 335 converts, for example, encoded signals output from the encoding part 329, generated pilot signals output from the first signal generating part 331, and generated signals output from the second signal generating part 333 into symbols. An IFFT (Inverse Fast Fourier Transform) part 337 generates OFDMA signals by performing an IFFT process on the signals output from the symbol mapper part 335.

A CP inserting part 339 inserts a CP part in the OFDMA signals generated by the IFFT part 337. A wireless transmitting part 341 includes an upconverter and an amplifier for converting the OFDMA signals with the inserted CP part into wireless signals.

With the above-described wireless terminal 300, uplink signals are transmitted after demodulating the downlink signals with the demodulating part 315 and measuring the reception quality of the downlink signals with the reception quality measuring part 322. The target for measuring reception quality may be, for example, an individual pilot signal. The reception quality may be, for example, CINR.

The reception quality measured by the reception quality measuring part 323 is converted into quality data by a quality data generating part (not illustrated). The quality data may be, for example data indicating the value of a reception level (e.g., 0x0a in a case of 10 dB).

The quality data are transmitted together with uplink data to the base station BS.

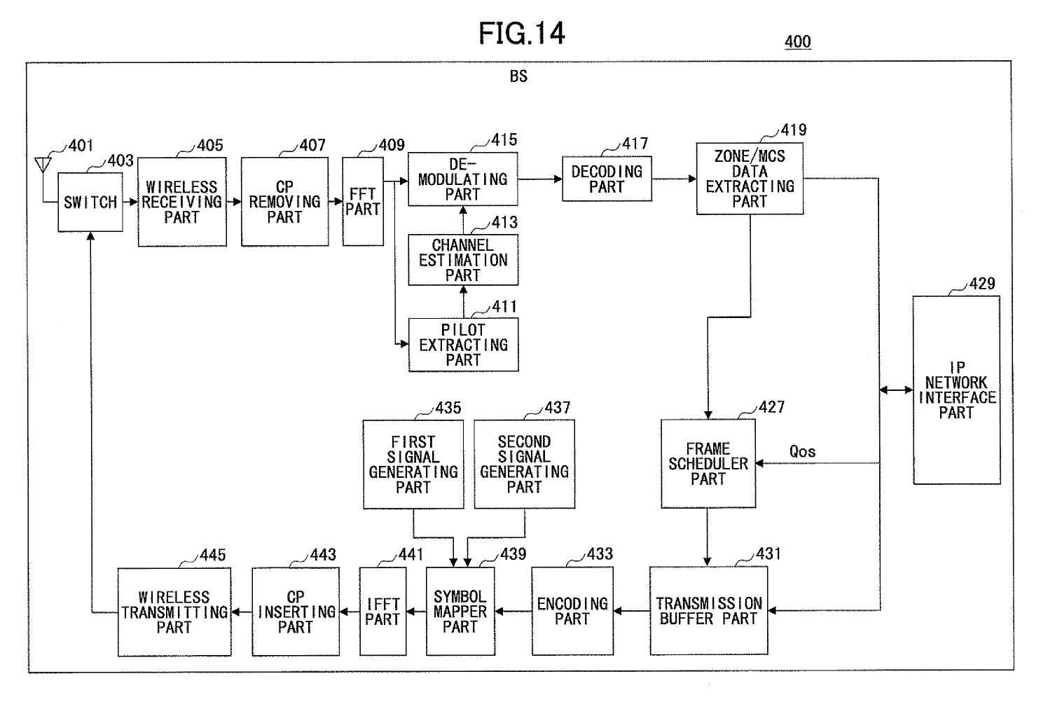

FIG. 14 is a block diagram illustrating an exemplary configuration of a wireless base station (BS) 400 according to the second and third embodiments of the present invention.

Components included in the wireless base station 400 are described below.

An antenna part 401 communicates with a wireless terminal (e.g., above-described wireless terminal 300) by transmitting and receiving a wireless signal(s) to and from the wireless terminal MS. A switch part 403, which is connected to the antenna part 401, switches back and forth between signal transmission and signal reception. A wireless receiving part 405, which is connected to the switch part 403, includes a down-converter that amplifies the wireless signal received by the antenna part 401 and converts the amplified signal into baseband signals.

A CP removing part 407 removes (extracts) a CP part from the baseband signals output from the wireless receiving part 405. A FFT processing part 409 extracts data from baseband signals by performing a Fast Fourier Transform (FFT) process on an OFDMA signal. A pilot extracting part 411 extracts a pilot signal from the OFDMA signal subjected to the FFT process.

A channel estimating part 413 estimates transmission conditions (Channel Estimation) based on the extracted pilot signal. A demodulating part 415 corrects and demodulates the data from the FFT processing part 409 by referring to the transmission conditions estimated by the channel estimating part 413. A decoding part 417 decodes the data demodulated by the demodulating part 415.

A zone/MCS data extracting part 419 extracts zone/MCS data transmitted from the wireless terminal MS from the data decoded by the decoding part 417. A frame scheduler part 427 generates downlink burst mapping and uplink burst mapping based on the zone/MCS data extracted by the zone/MCS data extracting part 419 and Quality of Service (QoS) data obtained from an IP network interface part 429. The IP network interface part 429 converts the data decoded by the decoding part 417 into, for example, MAC layer Protocol Data Unit (MAC-PDU), MAC layer Service Data Unit (MAC-SDU), and Internet Protocol (IP) packets, and provides an interface between the wireless base station 400 and an Access Service Network Gateway (ASN-GW).

A transmission buffer part 431 acts as a buffer of data based on the scheduling by the frame scheduler 427. An encoding part 433 encodes signals sent from the transmission buffer part 431. A first signal generating part 435 generates a downlink pilot signal and a preamble signal.

A second signal generating part 437 generates an FCH signal and a DL/UL-MAP signal. A symbol mapper part 439 converts the signals encoded by the encoding part 433, the signals generated by the first signal generating part 435, and the signals generated by the second signal generating part 437 into symbols according the modulation scheme to be applied. An IFFT part 441 generates OFDMA signals by performing an IFFT process on the signals output from the symbol mapper part 439.

A CP inserting part 443 inserts a CP part in the OFDMA signals generated by the IFFT part 337. A wireless transmitting part 445 includes an upconverter and an amplifier for converting the OFDMA signals with the inserted CP part into wireless signals.

With the above-described wireless base station 400, zone data and MCS data indicating the reuse zone and the MCS selected by the wireless terminal 300 are extracted after demodulating the uplink signals with the demodulating part 415 and decoding the demodulated signals with the decoding part 417.

It is to be noted that, in the above-described second and third embodiments of the present invention, it is assumed that the wireless terminal MS selects (determines) the reuse zone and the MCS, and reports data of the selected reuse zone and the selected MCS to the base station BS.

In another embodiment of the present invention, it is possible for the wireless terminal MS to select only the zone data whereas the base station BS selects the MCS based on zone data and quality data reported from the wireless terminal MS. In this case, the zone selecting part and a threshold setting part may be provided in the wireless terminal MS, and an MCS determining part may be provided in the base station BS.

In the above-described wireless base station 400 illustrated in FIG. 14, quality data indicating the reception quality of downlink signals measured by the wireless terminal 300 are extracted by the zone/MCS data extracting part 419 after uplink signals are demodulated and decoded. However, according to another embodiment of the present invention, the quality data may be extracted after the uplink signals are demodulated but without being decoded.

Next, an MCS table used by the MCS selecting part 325 for selecting an MCS (Modulation and Coding Scheme) is described with reference to FIG. 15. FIG. 15 is a schematic diagram illustrating an example of an MCS table.

In the MCS table illustrated in FIG. 15, CINR (Carrier to Interference plus Noise Ratio) is used to indicate reception quality. The MCS table illustrates a relationship between modulation schemes, FEC rates, CINR, and bit/symbol rates. As illustrated in FIG. 15, a modulation scheme of QPSK and an FEC rate of ½ are selected as MCS in a case where the CINR is 14 dB.

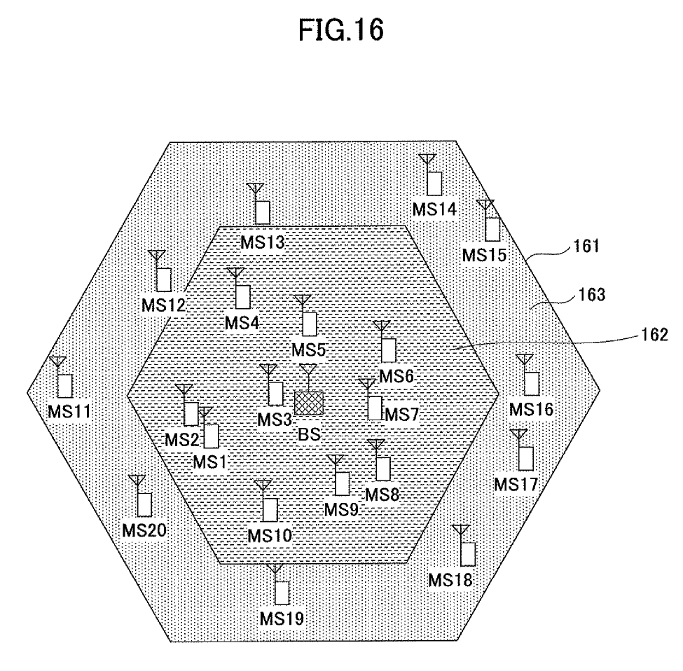

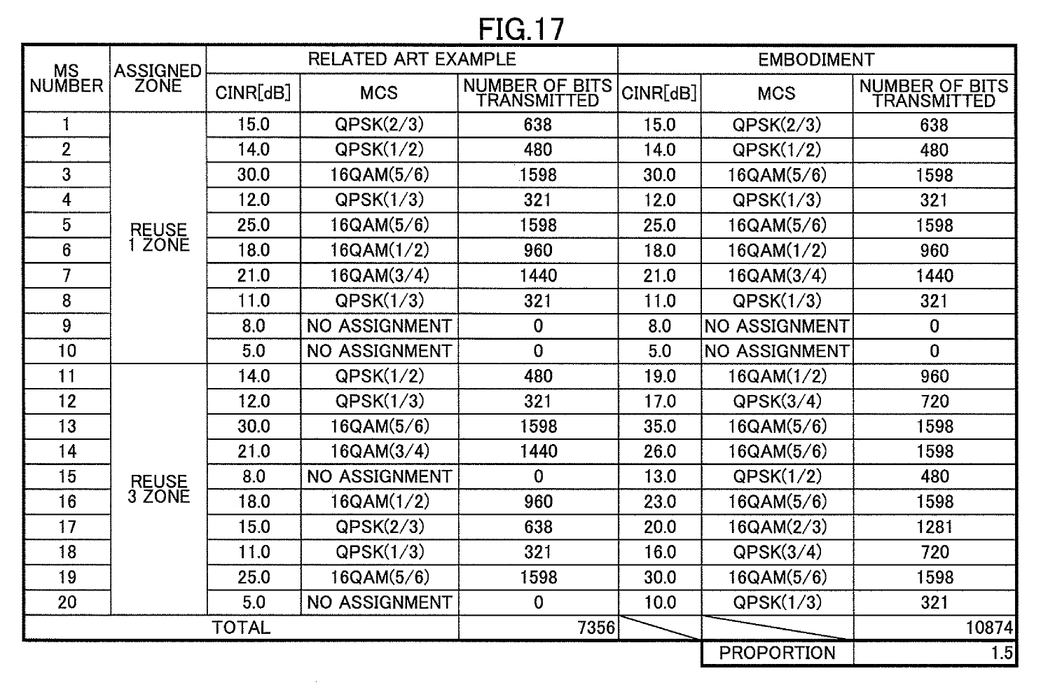

Next, effects that are attained by applying the communication method of the above-described embodiments of the present invention are described with one example of a wireless communication system and with reference to FIGS. 16 and 17. Although this example is described in a case where the communication method of the above-described embodiments of the present invention is applied to an IEEE 802.16 standard (WiMAX), the communication method of the above-described embodiments of the present invention may be applied to other standards.

FIG. 16 illustrates allocation of wireless terminals MS in an exemplary wireless communication system. In the wireless communication system illustrated in FIG. 16, one base station BS and twenty wireless terminals MS1 through MS20 are allocated in a cell 161. In this example, it is supposed that MS1 through MS10 are assigned to a Reuse 1 Zone 162 and MS11 through MS20 are assigned to a Reuse 3 Zone 163.

Although adjacent cells exist in an actual service area, illustration of the adjacent cells is omitted for the sake of simplifying explanation.

In this example, there are ten slots for data transmission. In this example, it is assumed that the MCS does not change during the ten slots. In a case where the ten slots are converted into symbols, the ten slots would be substantially equivalent to 480 symbols. For example, in a case of a MCS having a modulation scheme of QPSK and an FEC rate of ⅓, the number of transmission data bits X would be:

X=2×(⅓)×480=321 bits.

FIG. 17 illustrates the results of calculating the number of transmission bits in a case where a related art example is applied to the wireless communication system of FIG. 16 and a case where an embodiment of the present invention is applied to the wireless communication system of FIG. 16. In FIG. 17, reception quality is indicated by using CINR. For the sake of simplifying explanation, it is assumed that the values of all of the measured reception qualities are greater than the threshold for changing the reuse zone and that there is no changing of the reuse zone.

The number of transmission bits is the same for both the related art example and the embodiment of the present invention in the Reuse 1 Zone because the assigning of the resource zone and the selecting of MCS are performed based on the reception quality of the signal of the Reuse 1 Zone. For example, the CINR of the wireless terminal MS1 is 15.0 dB for both the related art example and the embodiment of the present invention.

On the other hand, the related art example exhibits a CINR value lower than that of the embodiment of the present invention. For example, the CINR of the wireless terminal MS11 is 14.0 dB for the related art example whereas the CINR of the wireless terminal MS11 is 19.0 dB for the embodiment of the present invention. This is because a signal of the Reuse 3 Zone (reuse 3 zone signal) generally has a greater transmission power than a signal of the Reuse 1 Zone (reuse 1 zone signal) so that the reuse 3 zone signal can reach the peripheral part of a cell. In other words, the reuse 3 zone signal has greater transmission power per sub-carrier compared to that of the reuse 1 zone signal. In this example, the difference of CINR due to the difference of transmission power is 5 dB. In other words, the CINR value measured by the embodiment of the present invention is 5 dB higher than that of the related art example.

The selection of the MCS based on the measured CINR is performed using, for example, the MCS table illustrated in FIG. 15.

Accordingly, because the wireless terminal MS11 according to the related art example has a CINR=14.0 dB, the MCS of the wireless terminal MS11 according to the related art example is QPSK (½) and the number of transmission bits is 480 bits. On the other hand, because the wireless terminal MS11 according to the embodiment of the present invention has a CINR=19.0 dB, the MCS of the wireless terminal MS11 according to the embodiment of the present invention is 16 QAM (½) and the number of transmission bits is 960 bits.

Likewise, the MCS and the number of transmission bits are obtained for the wireless terminals MS11 through MS20 by referring to the MCS table.

As a result, the total number of transmission bits of the wireless terminals MS11 through MS20 according to the related art example is 7,356 bits whereas the total number of transmission bits of the wireless terminals MS11 through MS20 according to the embodiment of the present invention is 10,874 bits. The total number of transmission bits obtained by applying the embodiment of the present invention is approximately 1.5 times greater than by applying the related art example. Thus, it can be understood that throughput can be increased by applying the embodiment of the present invention.

### MODIFIED EXAMPLE

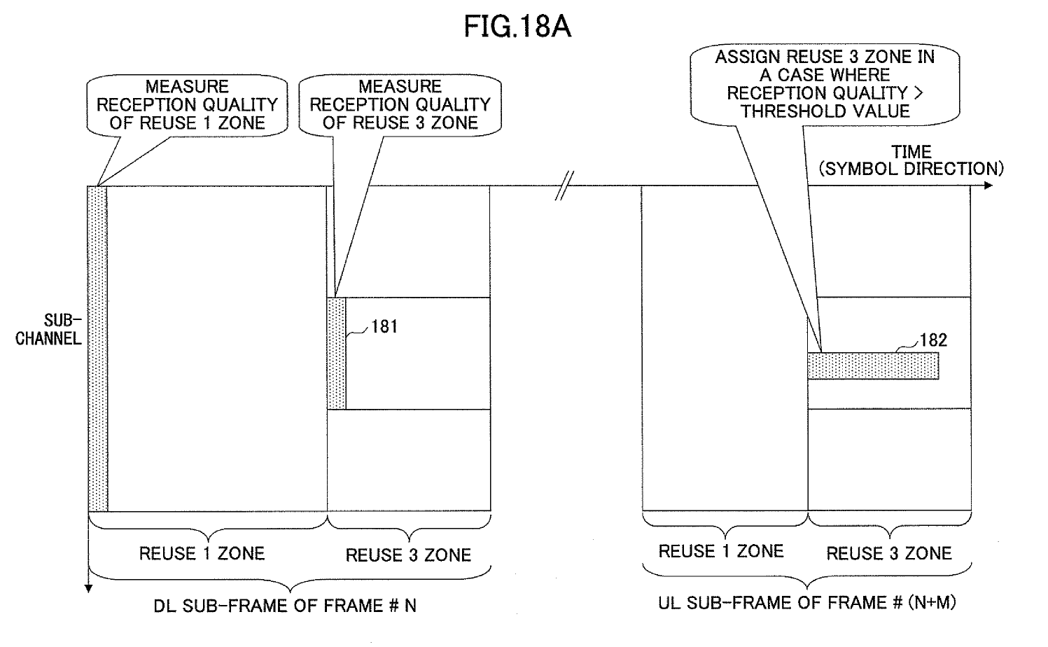

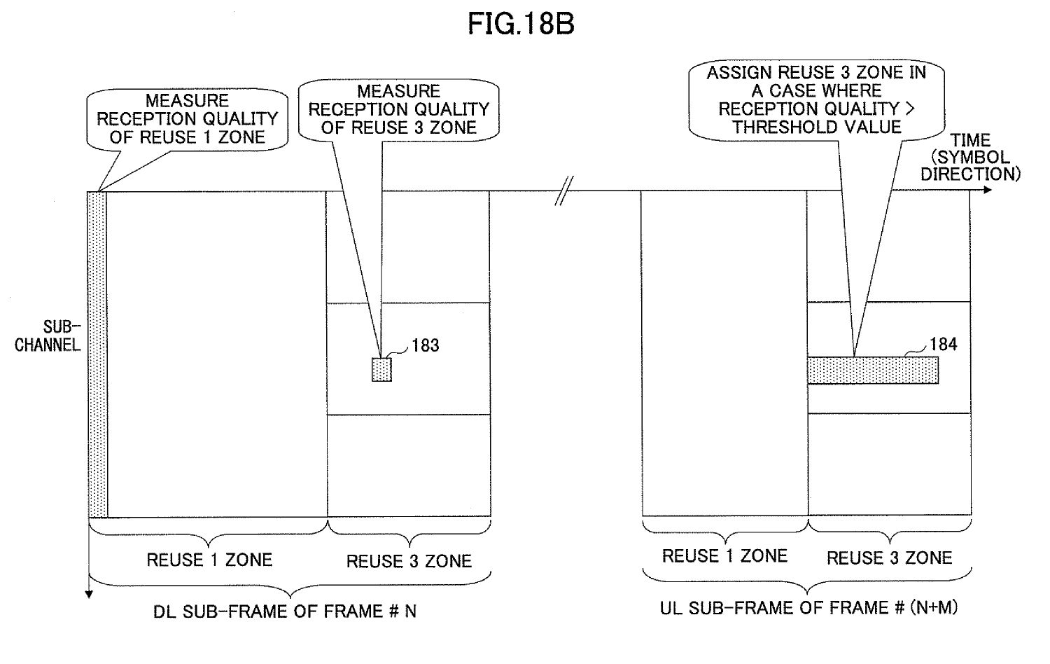

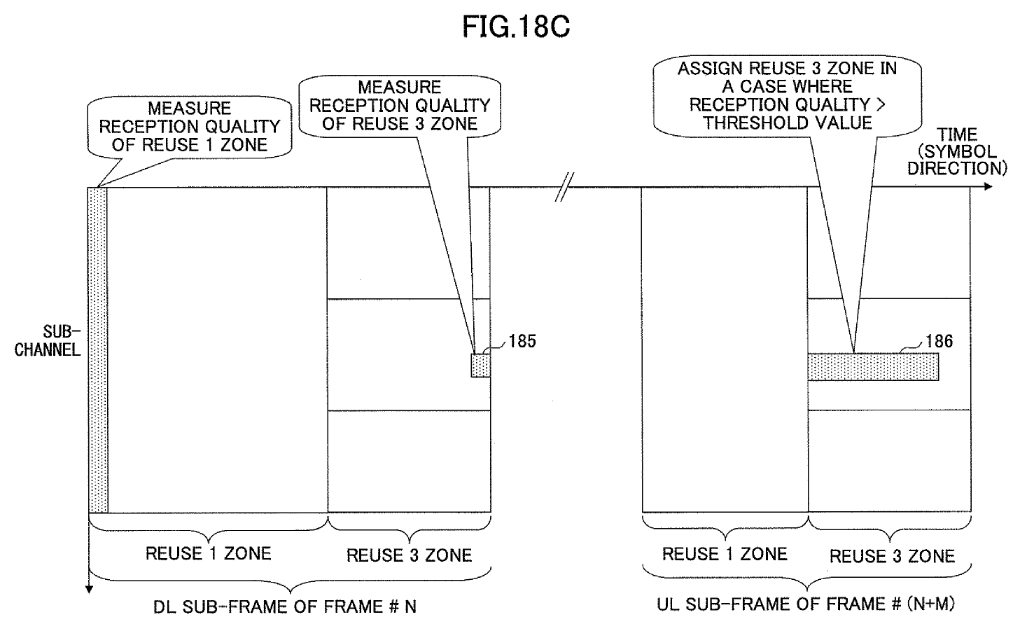

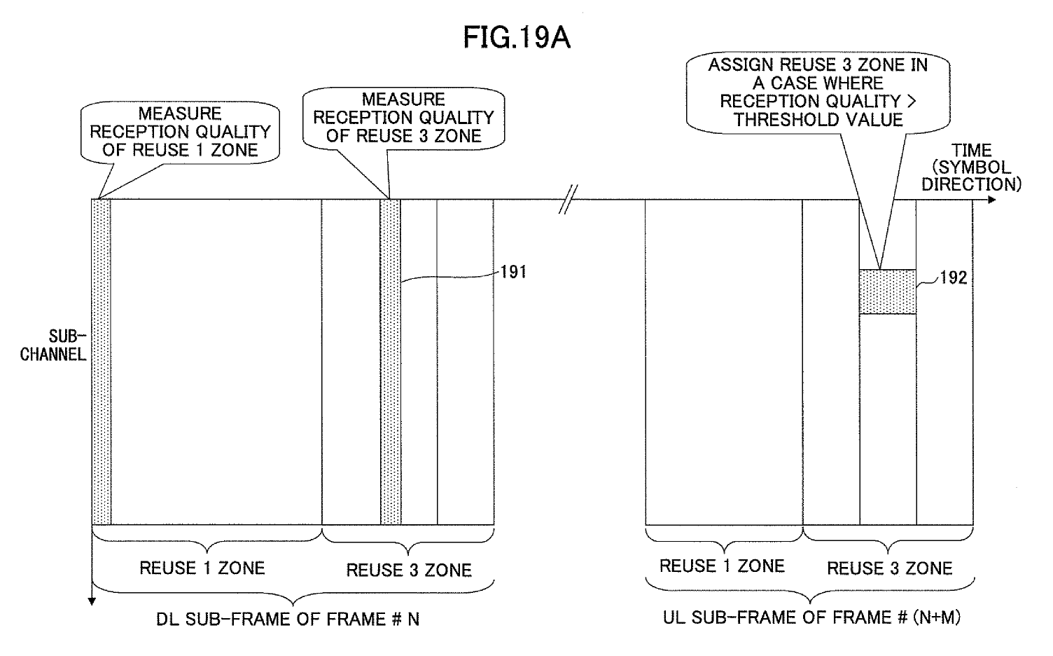

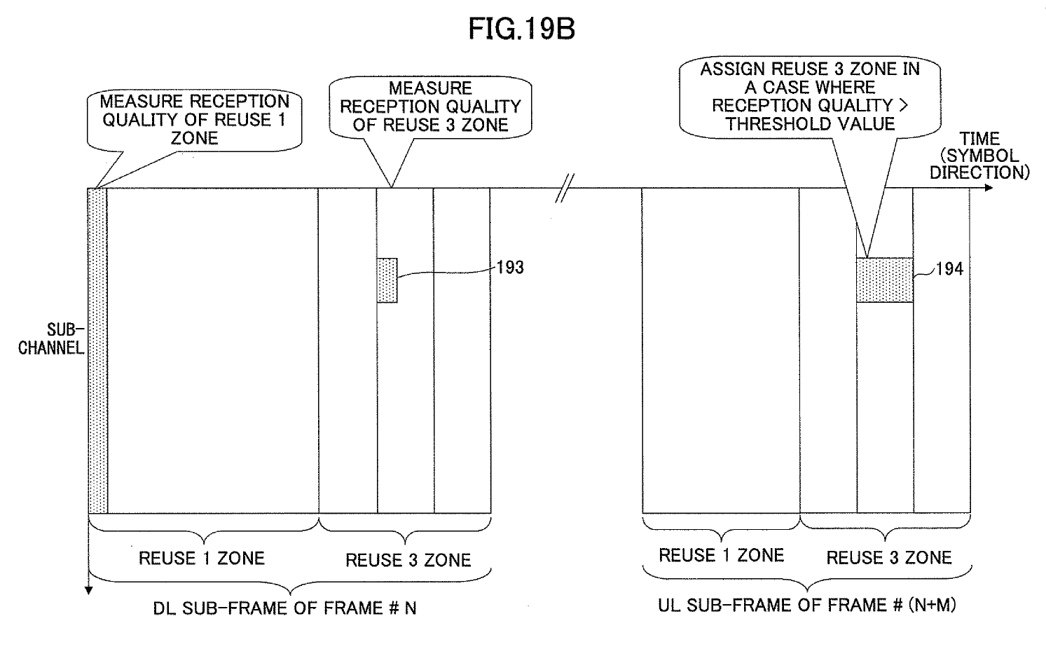

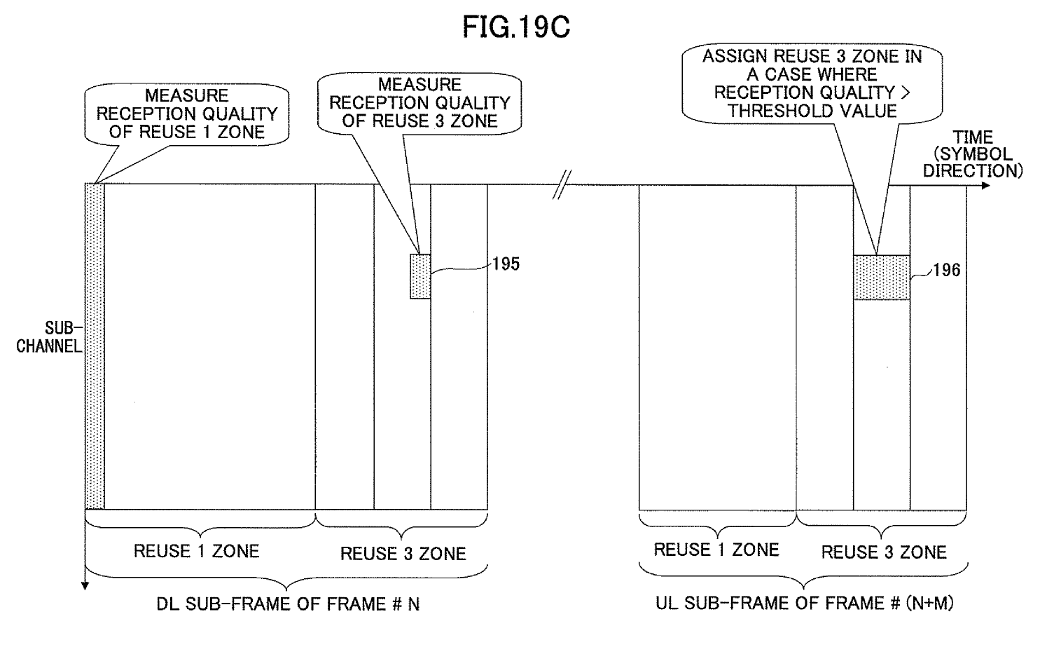

As described above, the reception quality of the Reuse 3 Zone is measured according to the above-described embodiments of the present invention. As illustrated in the below-described FIGS. 18A through 19C, there are many variations of measuring reception quality of the Reuse 3 Zone. Next, modified examples of the variations are described.

FIGS. 18A through 18C illustrate examples where one wireless base station performs wireless communications by using a frequency bandwidth different from that of an adjacent wireless base station in a Reuse 3 Zone.

FIGS. 19A through 19C illustrate examples where one wireless base station performs wireless communications with an adjacent wireless base station by time division.

### Modified Example 1

FIG. 18A illustrates modified example 1. In the modified example 1, a wireless terminal MS measures downlink reception qualities α1 and α3 in the Reuse 1 Zone and the Reuse 3 Zone. The operation of measuring reception qualities is substantially the same as the operation of the communication method of the above-described second and third embodiments of the present invention. However, in the modified example 1, a reuse zone is selected based on the average reception quality of all sub-channels (indicated with reference numeral 181 in FIG. 18A) when a wireless terminal MS measures downlink reception quality of the reuse zone assigned to the wireless terminal MS itself.

In the above-described modified example 1, the Reuse 3 Zone is assigned to the wireless terminal MS. However, in the case where the Reuse 1 Zone is assigned to the wireless terminal MS, the wireless terminal MS selects a reuse zone based on the average reception quality of the Reuse 1 Zone (not illustrated).

### Modified Example 2

FIG. 18B illustrates modified example 2. In the modified example 2, a wireless terminal MS measures downlink reception qualities α1 and α3 in the Reuse 1 Zone and the Reuse 3 Zone. The operation of measuring reception qualities is substantially the same as the operation of the communication method of the above-described second and third embodiments of the present invention. However, in the modified example 2, a reuse zone is selected based on the average reception quality of only the sub-channel used in uplink (indicated with reference numeral 183 in FIG. 18B) when a wireless terminal MS measures downlink reception quality of the reuse zone assigned to the wireless terminal MS itself. This allows transmission conditions of the sub-channels used in the uplink to be reflected with greater accuracy when performing wireless communications.

In the above-described modified example 2, the Reuse 3 Zone is assigned to the wireless terminal MS. However, in the case where the Reuse 1 Zone is assigned to the wireless terminal MS, the wireless terminal MS selects a reuse zone based on the average reception quality of only the sub-channel used in uplink of the Reuse 1 Zone (not illustrated).

### Modified Example 3

FIG. 18C illustrates modified example 3. In the modified example 3, a wireless terminal MS measures downlink reception qualities α1 and α3 in the Reuse 1 Zone and the Reuse 3 Zone. The operation of measuring reception qualities is substantially the same as the operation of the communication method of the above-described second and third embodiments of the present invention. However, in the modified example 3, a reuse zone is selected based on the average reception quality of only the sub-channel that is used in uplink and provided last in the time direction (indicated with reference numeral 185 in FIG. 18C) when a wireless terminal MS measures downlink reception quality of the reuse zone assigned to the wireless terminal MS itself. This allows transmission conditions of the sub-channels used in the uplink to be reflected with greater accuracy when performing wireless communications.

In the above-described modified example 3, the Reuse 3 Zone is assigned to the wireless terminal MS. However, in the case where the Reuse 1 Zone is assigned to the wireless terminal MS, the wireless terminal MS selects a reuse zone based on the average reception quality of only the sub-channel that is used in uplink and provided last in the time direction of the Reuse 1 Zone (not illustrated).

### Modified Example 4

A wireless base station BS may perform wireless communications using a time period different from a time period used by an adjacent wireless base station in a case where the Reuse 3 Zone is further divided into smaller time period. FIGS. 19A through 19C illustrate examples where the time period of the Reuse 3 Zone is divided into three time periods in a time direction. In these examples, the wireless base station BS performs wireless communications with a wireless terminal(s) in the Reuse 3 Zone by using one of the divided time periods that is different from a time period used by an adjacent wireless base station.

FIG. 19A illustrates modified example 4. In the modified example 4, a wireless terminal MS measures downlink reception qualities α1 and α3 in the Reuse 1 Zone and the Reuse 3 Zone. The operation of measuring reception qualities is substantially the same as the operation of the communication method of the above-described second and third embodiments of the present invention. However, in the modified example 4, a reuse zone is selected based on the average reception quality of all sub-channels of a time period provided in the middle one of the three divided time periods (indicated with reference numeral 191 in FIG. 19A) when a wireless terminal MS measures downlink reception quality of the reuse zone assigned to the wireless terminal MS itself.

In the above-described modified example 4, the Reuse 3 Zone is assigned to the wireless terminal MS. However, in the case where the Reuse 1 Zone is assigned to the wireless terminal MS, the wireless terminal MS selects a reuse zone based on the average reception quality of the sub-channel of the Reuse 1 Zone (not illustrated).

### Modified Example 5

FIG. 19B illustrates modified example 5. In the modified example 5, a wireless terminal MS measures downlink reception qualities α1 and α3 in the Reuse 1 Zone and the Reuse 3 Zone. The operation of measuring reception qualities is substantially the same as the operation of the communication method of the above-described second and third embodiments of the present invention. However, in the modified example 5, a reuse zone is selected based on the average reception quality of only the sub-channel used in uplink of a time period provided in the middle one of the three divided time periods (indicated with reference numeral 193 in FIG. 19B) when a wireless terminal MS measures downlink reception quality of the reuse zone assigned to the wireless terminal MS itself. This allows transmission conditions of the sub-channels used in the uplink to be reflected with greater accuracy when performing wireless communications.

In the above-described modified example 5, the Reuse 3 Zone is assigned to the wireless terminal MS. However, in the case where the Reuse 1 Zone is assigned to the wireless terminal MS, the wireless terminal MS selects a reuse zone based on the average reception quality of only the sub-channel used in uplink of a time period provided in the middle one of three divided time periods in the Reuse 1 Zone (not illustrated).

### Modified Example 6

FIG. 19C illustrates modified example 6. In the modified example 6, a wireless terminal MS measures downlink reception qualities α1 and α3 in the Reuse 1 Zone and the Reuse 3 Zone. The operation of measuring reception qualities is substantially the same as the operation of the communication method of the above-described second and third embodiments of the present invention. However, in the modified example 6, a reuse zone is selected based on the average reception quality of only the sub-channel used in uplink of a time period provided in the middle one of the three divided time periods and provided last in the time direction (indicated with reference numeral 195 in FIG. 19C) when a wireless terminal MS measures downlink reception quality of the reuse zone assigned to the wireless terminal MS itself. This allows transmission conditions of the sub-channels used in the uplink to be reflected with greater accuracy when performing wireless communications.

In the above-described modified example 6, the Reuse 3 Zone is assigned to the wireless terminal MS. However, in the case where the Reuse 1 Zone is assigned to the wireless terminal MS, the wireless terminal MS selects a reuse zone based on the average reception quality of only the sub-channel used in uplink of a time period provided in the middle one of three divided time periods in the Reuse 1 Zone (not illustrated).

### Fourth Embodiment

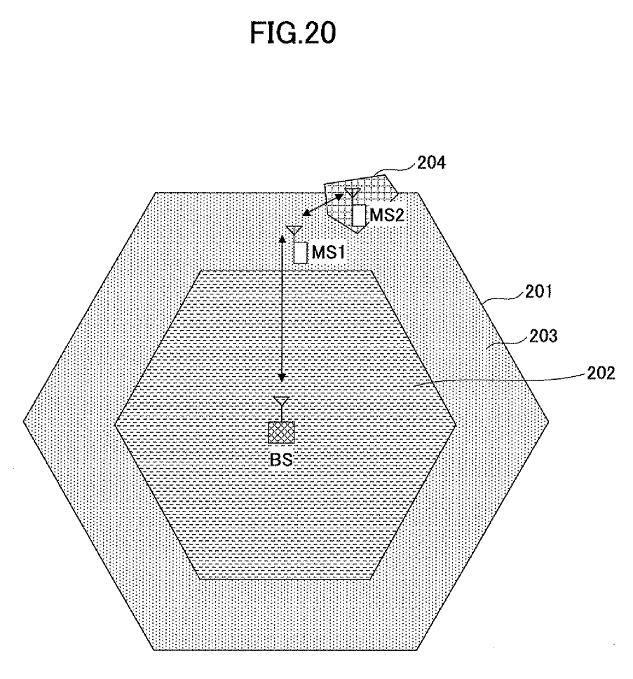

Next, a communication method according to a fourth embodiment of the present invention is described with reference to FIGS. 20-23. In the fourth embodiment, a cell 201 having a wireless base station BS in the center is provided as illustrated in FIG. 20. Further, a wireless terminal MS1 is provided in a Reuse 3 Zone 203 surrounding a Reuse 1 Zone 202. Further, a wireless terminal MS2 is provided in a blind area 204 in the Reuse 3 Zone 203. In this embodiment, the wireless terminal MS1 in the Reuse 3 Zone performs multi-hop relay communications.

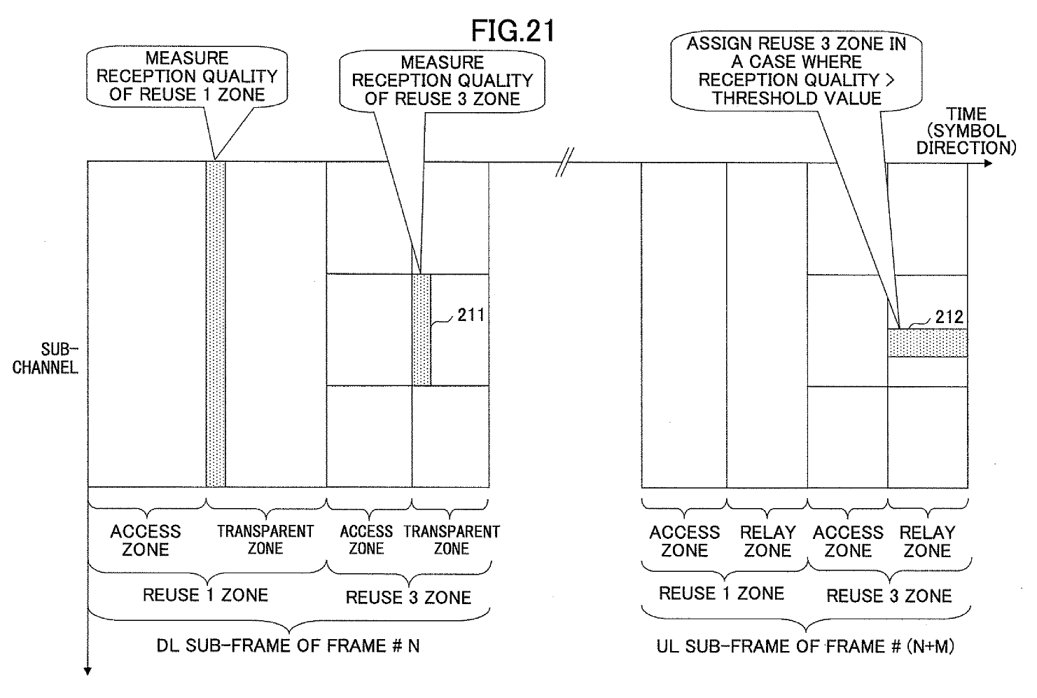

As illustrated in FIG. 21, in a case where the wireless terminal MS1 and the wireless terminal MS2 perform communications, the wireless terminal MS2 measures downlink reception qualities α1 and α3 of a transparent zone of the Reuse 1 Zone 202 and the Reuse 3 Zone 203 of a downlink sub-frame and selects a reuse zone based on the result of the measurement. The operation of measuring reception qualities is substantially the same as the operation of the communication method of the above-described second and third embodiments of the present invention. However, in the fourth embodiment, a reuse zone is selected based on the average reception quality of all sub-channels in the transparent zone of the Reuse 3 Zone (indicated with reference numeral 211 in FIG. 21) when the wireless terminal MS2 measures the downlink reception qualities.

In this embodiment, the Reuse 3 Zone is assigned to the wireless terminal MS2. However, in a case where the Reuse 1 Zone is assigned to the wireless terminal MS2, the MS2 selects a reuse zone based on the average reception quality of the Reuse 1 Zone (not illustrated).

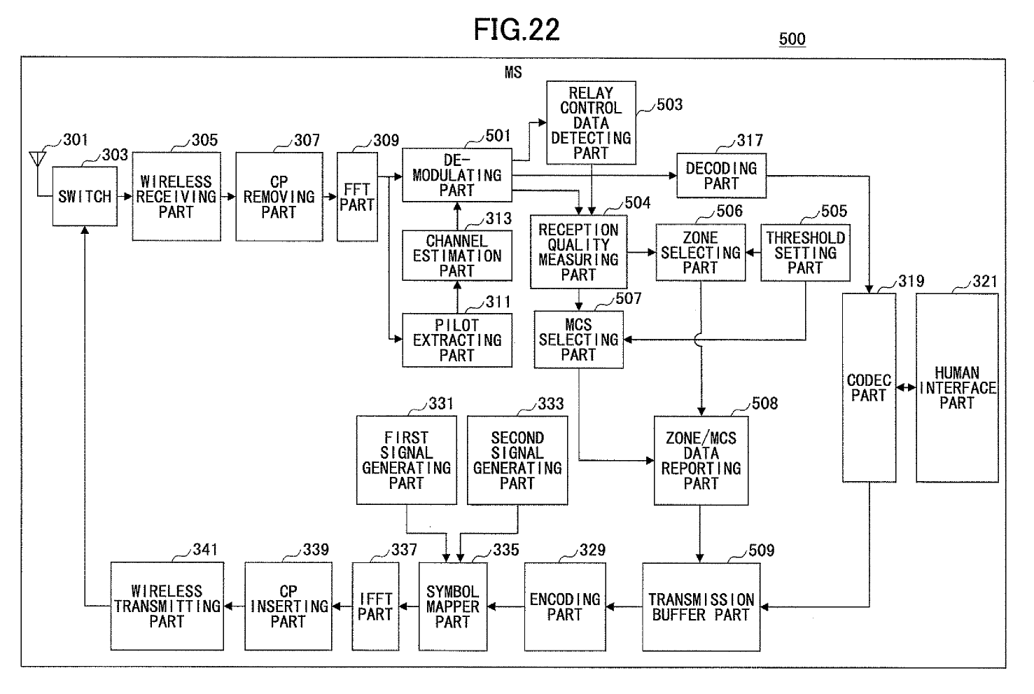

FIG. 22 is a block diagram illustrating an exemplary configuration of a wireless terminal 500 according to the fourth embodiment of the present invention.

Components included in the wireless terminal 500 are described below. In the wireless terminal 500 of the fourth embodiment of the present invention, like components are denoted with like reference numerals as of those of the above-described wireless terminal 300 of the second and third embodiments of the present invention (see FIG. 13) and are not further described.

A demodulating part 501 corrects and modulates the data from the FFT processing part 309 by referring to the transmission conditions estimated by the channel estimating part 313.

A relay control data detecting part 503 detects relay control data from the data demodulated by the demodulating part 501. The relay control data includes data for enabling the wireless terminal 500 to determine whether the wireless terminal 500 itself is to act as a relay terminal.

A reception quality measuring part 504 measures the downlink reception quality of the access zone or the transparent zone based on data output from the demodulating part and data output from the relay control data detecting part 503.

A threshold setting part 505 sets a threshold used for selecting a MCS.

A zone selecting part 506 selects a zone to be assigned to the wireless terminal 500 based on downlink reception quality data obtained from the reception quality measuring part 504 and threshold data obtained from the threshold setting part 505.

A MCS selecting part 507 selects a MCS based on the downlink reception quality data obtained from the reception quality measuring part 504 and the threshold data obtained from the threshold setting part 505.

A zone/MCS data reporting part 508 generates zone/MCS data based on the zone selected by the zone selecting part 506 and the MCS selected by the MCS selecting part 507 and sends the generated zone/MCS data to a transmission buffer part 509.

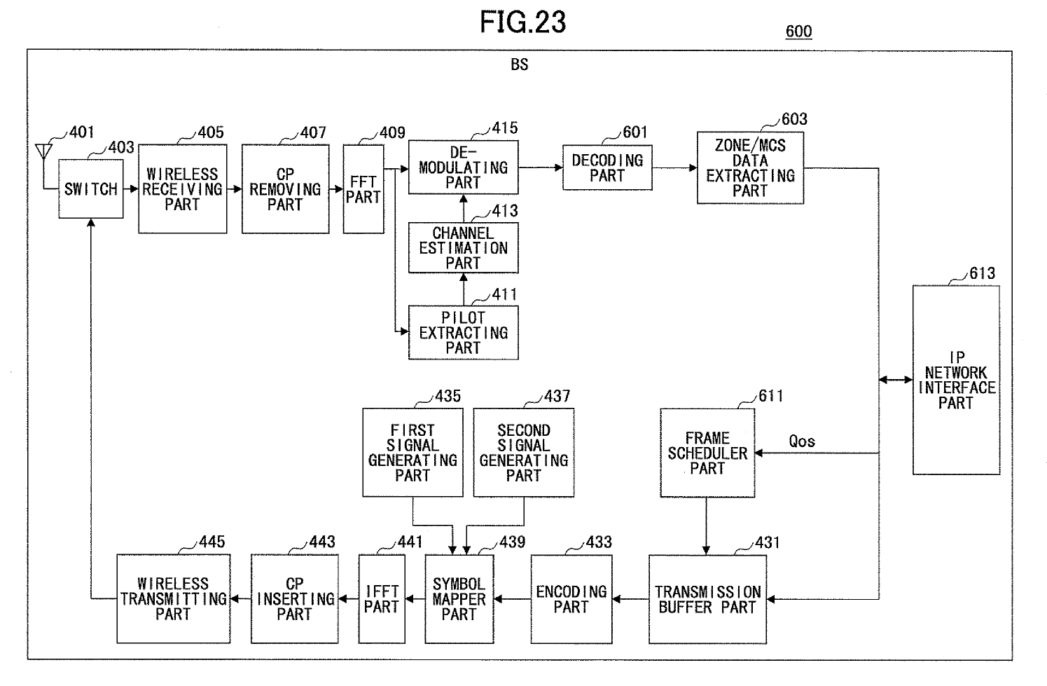

FIG. 23 is a block diagram illustrating an exemplary configuration of a wireless base station 600 according to the fourth embodiment of the present invention.

Components included in the wireless base station 600 are described below. In the wireless base station 600 of the fourth embodiment of the present invention, like components are denoted with like reference numerals as of those of the above-described wireless base station 400 of the second and third embodiments of the present invention (see FIG. 14) and are not further described.

A decoding part 601 decodes data demodulated by the demodulating part 415. A zone/MCS data extracting part 603 extracts zone/MCS data corresponding to each wireless terminal MS from the data decoding part 601.

A frame scheduler portion 611 generates downlink burst mapping and uplink burst mapping based on zone/MCS data extracted by the zone/MCS data extracting part 603 and service quality data (QoS) obtained from an IP network interface part 613.

Similar to the wireless base station 400 of FIG. 14, the wireless base station 600 uses the zone/MCS data extracting part 603 to extract zone data and MCS data indicating the zone and MCS selected by a wireless terminal MS after demodulating and decoding an uplink signal.

In the embodiments illustrated with FIGS. 22 and 23, the wireless terminal (MS) 500 selects a zone and a MCS and reports the selected zone and MCS to the wireless base station (BS) 600. In these embodiments, the MCS selecting part 507, the zone selecting part 506, and the threshold setting part 505 are provided in the wireless terminal 500, so that zone data and MCS data can be reported to the wireless base station 600.

According to another embodiment of the present invention, the wireless terminal 500 may measure reception quality and report the measured reception quality in the form of quality data, so that the wireless base station 600 can select the zone and the MCS.

In the above-described fourth embodiment, a reuse zone is selected from a reception quality of all sub-channels when the wireless terminal 500 (e.g., MS2) measures downlink reception quality of a transparent zone of a Reuse 3 Zone of a downlink sub-frame.

In another example of the fourth embodiment of the present invention, as described with the embodiment of FIG. 18B, a reuse zone may be selected based on the average reception quality of only the sub-channel used in uplink when a wireless terminal MS measures downlink reception quality of the reuse zone assigned to the wireless terminal MS itself.

In another example of the fourth embodiment of the present invention, as described with the embodiment of FIG. 18C, a reuse zone may be selected based on the average reception quality of only the sub-channel that is used in uplink and provided last in the time direction when a wireless terminal MS measures downlink reception quality of the reuse zone assigned to the wireless terminal MS itself.

The wireless base station 600 according to an embodiment of the present invention may perform wireless communications with other adjacent base stations by using a time division method instead of using frequencies different from those used by adjacent wireless base stations.

In another example of the fourth embodiment of the present invention, as described with the embodiment of FIG. 19A, a reuse zone may be selected based on the average reception quality of all sub-channels of a time period provided in the middle one of three divided time periods when a wireless terminal MS measures downlink reception quality of the reuse zone assigned to the wireless terminal MS itself.

In another example of the fourth embodiment of the present invention, as described with the embodiment of FIG. 19B, a reuse zone may be selected based on the average reception quality of only the sub-channel used in uplink of a time period provided in the middle one of three divided time periods when a wireless terminal MS measures downlink reception quality of the reuse zone assigned to the wireless terminal MS itself.

In another example of the fourth embodiment of the present invention, as described with the embodiment of FIG. 19C, a reuse zone may be selected based on the average reception quality of only the sub-channel used in uplink of a time period provided in the middle one of three divided time periods and provided last in the time direction when a wireless terminal MS measures downlink reception quality of the reuse zone assigned to the wireless terminal MS itself.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A wireless communication method for performing wireless communications between a wireless terminal and a wireless base station during a first time period or a second time period, the wireless communication method comprising:
determining whether the first time period or the second time period is assigned to the wireless terminal;
measuring a quality of a signal to be transmitted during the determined first or second time period;
selecting either the first time period or the second time period according to the measured quality of the signal; and
reporting selection data indicating the selected first or second time period or reporting measurement data indicating the measured quality of the signal to the wireless base station.

2. The wireless communication method as claimed in claim 1, further comprising:
selecting a MCS; and
reporting MCS data indicating the selected MCS together with the selection data to the wireless base station.

3. The wireless communication method as claimed in claim 1, wherein in the measuring, the quality of the signal is measured based on the average of all sub-channels of the signal, the average of the sub-channels used for uplink communication, or the average of the last sub-channel of the second time period among the sub-channels used for uplink communication in a case of measuring the quality of the signal to be transmitted during the determined second time period.

4. A wireless terminal for performing wireless communications with a wireless base station during a first time period or a second time period, the wireless communication terminal comprising:
a determining part configured to determine whether the first time period or the second time period is assigned to the wireless terminal;
a measuring part configured to measure a quality of a signal to be transmitted during the determined first or second time period;
a selecting part configured to select either the first time period or the second time period according to the measured quality of the signal; and
a reporting part configured to report selection data indicating the selected first or second time period or report measurement data indicating the measured quality of the signal to the wireless base station.

5. The wireless terminal as claimed in claim 4, further comprising:
a selecting part configured to select a MCS; and
a reporting part configured to report MCS data indicating the selected MCS together with the selection data to the wireless base station.

6. The wireless terminal as claimed in claim 4, wherein the measuring part is configured to measure the quality of the signal based on the average of all sub-channels of the signal, the average of the sub-channels used for uplink communication, or the average of the last sub-channel of the second time period among the sub-channels used for uplink communication in a case of measuring the quality of the signal to be transmitted during the second time period.

7. The wireless terminal as claimed in claim 4, further comprising:
a relay control data detecting part configured to detect relay control data indicating whether the wireless terminal is to act as a relay terminal;
wherein the measuring part is configured to measure a quality of a signal of an access zone or a transparent zone.

8. A wireless base station for performing wireless communications with a wireless terminal during a first time period or a second time period, the wireless base station comprising:
a receiving part configured to receive selection data indicating whether the first or the second time period is selected based on a quality of a signal measured by the wireless terminal or to receive quality data indicating a quality of a signal transmitted during a time period determined by the wireless terminal.

9. The wireless base station as claimed in claim 8, wherein the receiving part is configured to receive MCS data indicating a MCS selected by the wireless terminal together with the selection data from the wireless terminal.

10. A wireless communication system comprising:
a wireless base station; and
a wireless terminal for performing wireless communications with the wireless base station during a first time period or a second time period,
wherein the wireless base station includes
a determining part configured to determine whether the first time period or the second time period is assigned to the wireless terminal,
a measuring part configured to measure a quality of a signal to be transmitted during the determined first or second time period,
a selecting part configured to select either the first time period or the second time period according to the measured quality of the signal, and
a reporting part configured to report selection data indicating the selected first or second time period or report measurement data indicating the measured quality of the signal to the wireless base station.
